(19) United States
(12) Patent Application Publication
(10) Pub. No.: US 2012/0154262 A1
(43) Pub. Date: Jun. 21, 2012

(54) Pixel Circuit And Display Device

(75) Inventor: Yoshimitsu Yamauchi, Osaka-shi (JP)

(73) Assignee: SHARP KABUSHIKI KAISHA, Osaka-shi, Osaka (JP)

(21) Appl. No.: 13/392,892

(22) PCT Filed: May 24, 2010
(86) PCT No.: PCT/JP2010/058742

§ 371 Date: Feb. 28, 2012

(30) Foreign Application Priority Data
Sep. 7, 2009 (JP) 2009-206475

(51) Int. Cl. G09G 3/36

(52) U.S. Cl. 345/100; 345/98

(57) ABSTRACT

A display device which achieves low power consumption without causing an aperture ratio to be lowered is provided. A pixel circuit includes: an internal node which holds a voltage of the pixel data supplied to a display element part; a first switch circuit which transfers the voltage of the pixel data supplied from a data signal line to the internal node through at least a switch element; a second switch circuit which transfers a voltage supplied to a predetermined voltage supply line to the internal node without going through the switch element; and a control circuit which holds a predetermined voltage depending on the voltage of the pixel data held in the internal node, at one end of a first capacitance element and controls connection/disconnection of the second switch circuit.

### CROSS-REFERENCE TO RELATED APPLICATIONS

This application is a National Phase filing under 35 U.S.C. §371 of International Application No. PCT/JP2010/058742 filed on May 24, 2010, and which claims priority to Japanese Patent Application No. 2009-206475 filed on Sep. 7, 2009.

### TECHNICAL FIELD

The present invention relates to a pixel circuit and a display device including the pixel circuit, and more particularly to an active matrix type liquid crystal display device.

### BACKGROUND ART

A mobile terminal such as a mobile telephone or a mobile type game uses a liquid crystal display device as its displaying means in general. In addition, since the terminal such as the mobile telephone is driven by a battery, power consumption is strongly required to be low. Therefore, the contents (such as the time or battery remaining amount) which needs to be constantly displayed is displayed in a reflective sub-panel. In addition, recently, both of a normal display as a full-color display and a reflective type constant display have been required to be displayed on the same main panel.

FIG. 27 shows an equivalent circuit of a pixel circuit of a general active matrix type liquid crystal display device. In addition, FIG. 28 shows a circuit arrangement example of an active matrix type liquid crystal display device having m×n pixels. As shown in FIG. 28, a switch element composed of a thin-film transistor (TFT) is provided in each intersecting point of m source lines (data signal lines) and n scanning lines (scanning signal lines). As shown in FIG. 27, a liquid crystal element LC and a retentive capacitance Cs are connected in parallel through the TFT. The liquid crystal element LC has a laminated structure in which a liquid crystal layer is provided between a pixel electrode and an opposite electrode (common electrode). In addition, in FIG. 28, the TFT and the pixel electrode (black rectangular part) are only shown in each pixel circuit. The retentive capacitance Cs has one end connected to the pixel electrode, and another end connected to the capacitance line LCs, to stabilize a voltage of pixel data held in the pixel electrode. The retentive capacitance Cs prevents the voltage of the pixel data held in the pixel electrode from fluctuating due to a leak current of the TFT, a fluctuation in electric capacitance of the liquid crystal element LC between a black display and a white display due to dielectric constant anisotropy of liquid crystal molecules, and a voltage fluctuation generated through a parasitic capacitance between the pixel electrode and a peripheral wire. By sequentially controlling the voltage of the scanning line, the TFT connected to the one scanning line is turned on, and a voltage of the pixel data supplied to each source line by the scanning line is programmed in the corresponding pixel electrode.

As for the normal display as the full-color display, even when display contents include a still picture, by repeatedly programming the same display contents in the same pixel while inverting the polarity of the voltage applied to the liquid crystal element LC every one frame, the voltage of the pixel data held in the pixel electrode is updated, and the voltage fluctuation of the pixel data can be limited to the minimum, so that a high-quality still picture can be displayed.

The power consumption to drive the liquid crystal display device is mostly controlled by power consumption to drive the source line by the source driver, and can be roughly expressed by a relational expression shown in a formula 1 provided below. In the formula 1, P represents power consumption, f represents a refresh rate (the number of refreshing actions for one frame per unit time), C represents a load capacitance driven by the source driver, V represents a drive voltage of the source driver, n represents the number of scanning lines, and m represents the number of source lines. In addition, the refreshing action is performed to eliminate a fluctuation generated in voltage (absolute value) corresponding to the pixel data, and applied to the liquid crystal element LC by reprogramming the pixel data and regain an original voltage state corresponding to the pixel data.

P∝f·C·V²·n·m (Formula 1)

By the way, as for the constant display, since the display contents are the still picture, the voltage of the pixel data is not necessarily updated every one frame. Thus, in order to further reduce the power consumption of the liquid crystal display device, a refresh frequency is reduced at the time of the constant display in general. However, when the refresh frequency is reduced, the pixel data voltage held in the pixel electrode fluctuates due to the leak current of the TFT. In addition, since an average potential during each frame period is also lowered, the voltage fluctuation leads to a fluctuation in display brightness (transmission factor of liquid crystal) of each pixel, and this is observed as flicker. In addition, a display quality could be lowered such as a sufficient contrast cannot be obtained.

Here, a patent document 1 discloses a configuration as a method to solve the problem that the display quality is lowered due to reduction in the refresh frequency and to reduce the power consumption, in the constant display for the still picture such as the battery remaining amount or the time. According to the configuration disclosed in the patent document 1, a liquid crystal display can be implemented by both transmissive type and reflective type functions, and a memory part is provided in a pixel circuit in a pixel region for the reflective type liquid crystal display. This memory part holds information to be displayed in a display part of the reflective type liquid crystal as a voltage signal. At the time of the reflective type liquid crystal display, the pixel circuit reads the voltage held in the memory part, and the information corresponding to that voltage is displayed.

According to the patent document 1, since the memory part is composed of a SRAM, and the voltage signal is statically held, the refreshing action is not needed, so that the display quality can be maintained, and the power consumption can be reduced.

### PRIOR ART DOCUMENT

### Patent Document

Patent document 1: Japanese Unexamined Patent Application Publication No. 2007-334224

### DISCLOSURE OF THE INVENTION

### Problems to be Solved by the Invention

However, when the above configuration is employed in the liquid crystal display device used in the mobile phone or the like, it is necessary to provide the memory part to store the pixel data every one pixel or every one pixel group, in addition to the retentive capacitance to hold the voltage of the pixel data as analog information at the time of normal action. Thus, there is an increase in the number of elements and signal lines to be formed on an array substrate (active matrix substrate) serving as a display part in the liquid crystal display device, so that an aperture ratio is lowered in a transmissive mode. In addition, when a polarity inverting drive circuit for AC driving in the liquid crystal is provided together with the memory part, the aperture ratio is further lowered. Thus, when the aperture ratio is lowered due to the increase in the element number or the signal line number, the brightness of the display image is lowered in the normal display mode.

In the liquid crystal display device, when the still picture is displayed in the constant display, in addition to the problem of the voltage fluctuation in the pixel electrode, there is a problem that after the voltage having the same polarity is continuously applied between the pixel electrode and the opposite electrode, a small amount of ion impurity contained in the liquid crystal layer concentrates on the side of the pixel electrode or the opposite electrode, so that the whole display screen is burnt. Therefore, in addition to the above-described refreshing action, it is necessary to perform a polarity inverting action to invert the polarity of the voltage applied between the pixel electrode and the opposite electrode.

According to the polarity inverting action, in each case of the normal display and the constant display, when the still picture is displayed, pixel data for one frame is stored in a frame memory, and a voltage corresponding to the pixel data is repeatedly programmed while its polarity based on the opposite electrode is inverted each time. Thus, as described above, it is necessary to externally drive the scanning line and the source line, and program the voltage of the pixel data supplied to each source line, in each pixel electrode by the scanning line.

Therefore, in the constant display requiring an action performed with low power consumption, when the polarity inverting action is performed by externally driving the scanning line and the source line, the power consumption further increases because a voltage amplitude of the pixel electrode is larger than that of the above refreshing action.

The present invention was made in view of the above problems, and it is an object of the present invention to provide a pixel circuit and a display device capable of preventing a liquid crystal from deteriorating and a display quality from being lowered with low power consumption without causing an aperture ratio to be lowered.

### Means for Solving the Problem

In order to attain the above object, according to the present invention, a pixel circuit includes a display element part including a unit liquid crystal display element, an internal node serving as a part of the display element part, adapted to hold a voltage of pixel data applied to the display element part, a first switch circuit adapted to transfer the voltage of the pixel data supplied from a data signal line to the internal node through at least a predetermined switch element, a second switch circuit adapted to transfer a voltage supplied to a predetermined voltage supply line to the internal node without going through the switch element, and a control circuit adapted to hold a predetermined voltage depending on the voltage of the pixel data held in the internal node, at one end of a first capacitance element, and control connection/disconnection of the second switch circuit, in which

the second switch circuit and the control circuit include first to third transistor elements each having a first terminal, a second terminal, and a control terminal to control connection between the first and second terminals, and the first capacitance element, the second switch circuit includes a series circuit of the first transistor element and the third transistor element, the control circuit includes a series circuit of the second transistor element and the first capacitance element,

one end of the first switch circuit is connected to the data signal line, one end of the second switch circuit is connected to the voltage supply line, each of other ends of the first and second switch circuits, and the first terminal of the second transistor element are connected to the internal node, the control terminal of the first transistor element, the second terminal of the second transistor element, and the one end of the first capacitance element are mutually connected, the control terminal of the second transistor element is connected to a first control line, the control terminal of the third transistor element is connected to a second control line, and the other end of the first capacitance element is connected to a predetermined fixed voltage line.

In addition, it is preferable that the pixel circuit having the above characteristics includes a second capacitance element having one end connected to the internal node, and the other end connected to the fixed voltage line, and the fixed voltage line functions as a third control line to control the voltage of the internal node by capacitance coupling through the second capacitance element.

In addition, it is preferable that in the pixel circuit having the above characteristics, the switch element includes a fourth transistor element having a first terminal, a second terminal, and a control terminal adapted to control connection between the first and second terminals, and the control terminal of the fourth transistor element is connected to a scanning signal line.

It is preferable that in the pixel circuit having the above characteristics, the first switch circuit consists of the switch element, or the first switch circuit includes a series circuit of the switch element and the third transistor element, or a series circuit of the switch element and a fifth transistor element having a control terminal connected to the control terminal of the third transistor element.

Furthermore, it is preferable that in the pixel circuit having the above characteristics, the first control line or the fixed voltage line also serves as the voltage supply line when the first switch circuit consists of the switch element.

In addition, it is preferable that in the pixel circuit having the characteristics, the data signal line also serves as the voltage supply line.

Furthermore, in order to attain the above object, according to the present invention, as first characteristics, in a display device, a pixel circuit array is provided by arranging a plurality of pixel circuits each having the above characteristics in a row direction and a column direction,

the data signal line is provided every one column, the one end of the first switch circuit in each of the pixel circuits arranged in the same column is connected to the common data signal line, the control terminal of the second transistor element in each of the pixel circuits arranged in the same row or the same column is connected to the common first control line, the control terminal of the third transistor element in each of the pixel circuits arranged in the same row or the same column is connected to the common second control line, the other end of the first capacitance element in each of the pixel circuits arranged in the same row or the same column is connected to the common fixed voltage line,

a data signal line drive circuit adapted to drive the data signal lines separately and a control line drive circuit adapted to drive the first control line, the second control line, and the fixed voltage line separately are provided,

the data signal line drive circuit drives the voltage supply line in the case where the data signal line also serves as the voltage supply line, and the control line drive circuit drives the voltage supply line in the case where the first control line or the fixed voltage line also serves as the voltage supply line, or the voltage supply line is an independent wire.

In addition, it is preferable that in the display device having the first characteristics, in the case where none of the first control line, the fixed voltage line, or the data signal line also serves as the voltage supply line, and the voltage supply line is the independent wire, the one end of the second switch circuit in each of the pixel circuits arranged in the same row or the same column is connected to the common voltage supply line.

In addition, as second characteristics, in the display device having the first characteristics, the first switch circuit consists of the switch element including a fourth transistor element having a first terminal, a second terminal, and a control terminal adapted to control connection between the first and second terminals, the first terminal is connected to the internal node, the second terminal is connected to the data signal line, and the control terminal is connected to a scanning signal line in the fourth transistor element, the scanning signal line is provided every one row, the pixel circuits arranged in the same row are connected to the common scanning signal line, and a scanning signal line drive circuit to drive the scanning signal lines separately is provided.

In addition, as third characteristics, in the display device having the first characteristics, the first switch circuit includes a series circuit of the switch element including a fourth transistor element having a first terminal, a second terminal, and a control terminal adapted to control connection between the first and second terminals, and the third transistor element, or a series circuit of the switch element and a fifth transistor element having a control terminal connected to the control terminal of the third transistor element, the control terminal of the fourth transistor element is connected to a scanning signal line, the scanning signal line and the second control line are each provided every one row, the pixel circuits arranged in the same row are connected to each of the common scanning signal line and the common second control line, a scanning signal line drive circuit adapted to drive the scanning signal lines separately is provided, and the voltage supply line also serves as the data signal line or is the independent wire.

As fourth characteristics, in the display device having the second characteristics, at the time of a programming action to separately program the pixel data in the pixel circuits arranged in one selected row, the scanning signal line drive circuit applies a predetermined selected row voltage to the scanning signal line in the selected row to turn on the fourth transistor element arranged in the selected row, and applies a predetermined unselected row voltage to the scanning signal line in the row other than the selected row to turn off the fourth transistor element arranged in the row other than the selected row, and the data signal line drive circuit separately applies a data voltage corresponding to the pixel data to be programmed in the pixel circuit in each column in the selected row, to each of the data signal lines.

In addition, it is preferable that in the display device having the fourth characteristics, at the time of the programming action, the control line drive circuit applies a predetermined voltage to turn off the third transistor element, to the second control line, or in the case where the data signal line does not serve as the voltage supply line at the time of the programming action, the control line drive circuit applies a predetermined voltage to the first control line to turn on the second transistor element regardless of a voltage state of the internal node, and applies a predetermined voltage to the voltage supply line to turn off the first transistor element, and puts the second switch circuit into an unconnected state.

As fifth characteristics, in the display device having the third characteristics, at the time of a programming action to separately program the pixel data in the pixel circuits arranged in one selected row,

the scanning signal line drive circuit applies a predetermined selected row voltage to the scanning signal line in the selected row to turn on the fourth transistor element arranged in the selected row, applies a predetermined unselected row voltage to the scanning signal line in the row other than the selected row to turn off the fourth transistor element arranged in the row other than the selected row, the control line drive circuit applies a predetermined selecting voltage to the second control line in the selected row to turn on the third transistor element, and applies a predetermined non-selecting voltage to the second control line in the row other than the selected row to turn off the third transistor element, and the data signal line drive circuit separately applies a data voltage corresponding to the pixel data to be programmed in the pixel circuit in each column in the selected row, to each of the data signal lines,

or in the case where the voltage supply line is the independent wire, the scanning signal line drive circuit applies a predetermined selected row voltage to the scanning signal line in the selected row to turn on the fourth transistor element arranged in the selected row, applies a predetermined unselected row voltage to the scanning signal line in the row other than the selected row to turn off the fourth transistor element arranged in the row other than the selected row, the control line drive circuit applies a predetermined selecting voltage to turn on the third transistor element, to the second control line in the selected row, applies a predetermined voltage to turn on the second transistor element regardless of a voltage state of the internal node to the first control line, applies a predetermined voltage to turn off the first transistor element to the voltage supply line, and puts the second switch circuit into an unconnected state, and the data signal line drive circuit separately applies a data voltage corresponding to the pixel data to be programmed in the pixel circuit in each column in the selected row, to each of the data signal lines.

In addition, in the display device having the fourth or fifth characteristics, at the time of the programming action, the control line drive circuit may apply a predetermined voltage to turn on the second transistor element, to the first control line, or may apply a predetermined voltage to turn off the second transistor element, to the first control line.

In addition, it is preferable that in the display device having the fourth or fifth characteristics, after the programming action,

the scanning signal line drive circuit applies a predetermined voltage to the scanning signal line connected to all of the pixel circuits in the pixel circuit array to turn off the fourth transistor element,

the control line drive circuit applies a predetermined voltage to the second control line to turn off the third transistor element, or in the case where the data signal line does not serve as the voltage supply line, applies a predetermined voltage to the voltage supply line to turn off the first transistor element, and puts the second switch circuit into the unconnected state, and applies a predetermined voltage to the first control line so that a difference is generated in voltage value induced at one end of the first capacitance element through the second transistor element, depending on whether a voltage state of binary pixel data held in the internal node is a first voltage state or a second voltage state, and in the case where a voltage of the first or second terminal of the first transistor element is in the second voltage state, the first transistor element is turned on when the internal node is in the first voltage state, and the first transistor element is turned off when the internal node is in the second voltage state, due to the difference in voltage value at the one end of the first capacitance element.

In addition, as sixth characteristics, in the display device having the second or fourth characteristics, the unit liquid crystal display element includes a pixel electrode, an opposite electrode, and a liquid crystal layer sandwiched between the pixel electrode and the opposite electrode, the internal node is connected to the pixel electrode directly or through a voltage amplifier in the display element part, an opposite electrode voltage supply circuit adapted to supply a voltage to the opposite electrode is provided,

in a self polarity inverting action to activate the first switch circuits, the second switch circuits, and the control circuits to invert polarities of voltages applied between the pixel electrodes and the opposite electrodes in the plurality of pixel circuits at the same time,

as an initial state setting action before the self polarity inverting action,

the scanning signal line drive circuit applies a predetermined voltage to the scanning signal lines connected to all of the pixel circuits in the pixel circuit array to turn off the fourth transistor element,

the control line drive circuit applies a predetermined voltage to the first control line so that a difference is generated in voltage value induced at one end of the first capacitance element through the second transistor element, depending on whether a voltage state of binary pixel data held in the internal node is a first voltage state or a second voltage state, and in the case where a voltage of the first or second terminal of the first transistor element is in the second voltage state, the first transistor element is turned on when the internal node is in the first voltage state, and the first transistor element is turned off when the internal node is in the second voltage state, due to the difference in voltage value at the one end of the first capacitance element, and applies a predetermined fixed voltage to the fixed voltage line,

the control line drive circuit applies a predetermined voltage to the second control line to turn off the third transistor element, or in the case where the data signal line does not serve as the voltage supply line, applies a predetermined voltage to the voltage supply line to turn off the first transistor element, and puts the second switch circuit into the unconnected state,

after the initial state setting action,

the control line drive circuit applies a predetermined voltage to the first control line to turn off the second transistor element regardless of whether the internal node is in the first voltage state or the second voltage state, the scanning signal line drive circuit applies a voltage pulse having a predetermined voltage amplitude to all of the scanning signal lines connected to the plurality of pixel circuits serving as a target of the self polarity inverting action, turns on the fourth transistor element temporarily, and turns off the fourth transistor element, the opposite electrode voltage supply circuit changes a voltage applied to the opposite electrode between two voltage states after the second transistor element has been turned off, before the scanning signal line drive circuit completes the application of the voltage pulse, the control line drive circuit applies a predetermined voltage to the second control line to turn on the third transistor element during at least a predetermined period after the scanning signal line drive circuit has completed the application of the voltage pulse, the data signal line drive circuit applies a voltage in the first voltage state to all of the data signal lines connected to the pixel circuits serving as the target of the self polarity inverting action at least while the scanning signal line drive circuit applies the voltage pulse, and the data signal line drive circuit or the control line drive circuit applies a voltage in the second voltage state to all of the voltage supply lines connected to the pixel circuits serving as the target of the self polarity inverting action during at least one part of a period just before the control line drive circuit completes the application of the predetermined voltage to turn on the third transistor element to the second control line.

Further preferably, in the display device having the sixth characteristics, in the case where the first control line also serves as the voltage supply line, after the initial state setting action, the control line drive circuit applies the voltage in the second voltage state to the first control line as the predetermined voltage to turn off the second transistor element regardless of the voltage state of the internal node.

Further preferably, in the display device having the sixth characteristics, in the case where the fixed voltage line also serves as the voltage supply line, the control line drive circuit applies the voltage in the second voltage state as the predetermined fixed voltage in the initial state setting action.

Further preferably, in the display device having the sixth characteristics, a second capacitance element having one end connected to the internal node and the other end connected to a fixed voltage line is provided, and in the case where the fixed voltage line functions as a third control line to control a voltage of the internal node by capacitance coupling through the second capacitance element, after the scanning signal line drive circuit has completed the application of the voltage pulse, a voltage fluctuation of the internal node generated after the application of the voltage pulse is compensated by adjusting a voltage of the fixed voltage line.

In addition, as seventh characteristics, in the display device having the third or fifth characteristics, the unit liquid crystal display element includes a pixel electrode, an opposite electrode, and a liquid crystal layer sandwiched between the pixel electrode and the opposite electrode, the internal node is connected to the pixel electrode directly or through a voltage amplifier in the display element part, an opposite electrode voltage supply circuit adapted to supply a voltage to the opposite electrode is provided,

in a self polarity inverting action to activate the first switch circuits, the second switch circuits, and the control circuits to invert polarities of voltages applied between the pixel electrodes and the opposite electrodes in the plurality of pixel circuits at the same time,

as an initial state setting action before the self polarity inverting action,

the scanning signal line drive circuit applies a predetermined voltage to the scanning signal line connected to all of the pixel circuits in the pixel circuit array and turns off the fourth transistor element,

the control line drive circuit applies a predetermined voltage to the first control line so that a difference is generated in voltage value induced at one end of the first capacitance element through the second transistor element, depending on whether a voltage state of binary pixel data held in the internal node is a first voltage state or a second voltage state, and in the case where a voltage of the first or second terminal of the first transistor element is in the second voltage state, the first transistor element is turned on when the internal node is in the first voltage state, and the first transistor element is turned off when the internal node is in the second voltage state, due to the difference in voltage value at the one end of the capacitance element, and applies a predetermined fixed voltage to the fixed voltage line,

the control line drive circuit applies a predetermined voltage to the second control line to turn off the third transistor element, or in the case where the voltage supply line is the independent wire, applies a predetermined voltage to the voltage supply line to turn off the first transistor element and puts the second switch circuit into the unconnected state,

after the initial state setting action,

the control line drive circuit applies a predetermined voltage to the first control line to turn off the second transistor element regardless of whether the internal node is in the first voltage state or the second voltage state, the scanning signal line drive circuit applies a voltage pulse having a predetermined voltage amplitude to all of the scanning signal lines connected to the plurality of pixel circuits serving as a target of the self polarity inverting action, turns on the fourth transistor element temporarily, and turns off the fourth transistor element, the opposite electrode voltage supply circuit changes a voltage applied to the opposite electrode between two voltage states after the second transistor element has been turned off, before the scanning signal line drive circuit completes the application of the voltage pulse, the control line drive circuit applies a predetermined voltage to the second control line to turn on the third transistor element at least during a period when the scanning signal line drive circuit applies the voltage pulse and a predetermined period after the application has been completed, the data signal line drive circuit applies a voltage in the first voltage state to all of the data signal lines connected to the pixel circuits serving as the target of the self polarity inverting action at least while the scanning signal line drive circuit applies the voltage pulse, and the data signal line drive circuit or the control line drive circuit applies the voltage in the first voltage state at least while the scanning signal line drive circuit applies the voltage pulse, and applies a voltage in the second voltage state after the scanning signal line drive circuit has completed the application of the voltage pulse and during at least one part of a period just before the control line drive circuit completes the application of a predetermined voltage to turn on the third transistor element to the second control line, to all of the voltage supply lines connected to the pixel circuits serving as the target of the self polarity inverting action.

Further preferably, in the display device having the seventh characteristics, a second capacitance element having one end connected to the internal node and the other end connected to a fixed voltage line is provided, and in the case where the fixed voltage line functions as a third control line to control a voltage of the internal node by capacitance coupling through the second capacitance element, after the scanning signal line drive circuit has completed the application of the voltage pulse, a voltage fluctuation of the internal node generated at the completion of the application of the voltage pulse is compensated by adjusting a voltage of the fixed voltage line.

As eighth characteristics, in the display device having the sixth or seventh characteristics, after a series of actions following the initial state setting action has been completed, the control line drive circuit applies a predetermined voltage to the second control line to turn off the third transistor element, or in the case where the data signal line does not serve as the voltage supply line, applies a predetermined voltage to the voltage supply line to turn off the first transistor element, and puts the second switch circuit into the unconnected state, and applies a predetermined voltage to the first control line so that a difference is generated in voltage value induced at one end of the first capacitance element through the second transistor element depending on whether the voltage state of the binary pixel data held in the internal node is in a first voltage state or a second voltage state, and in the case where a voltage of the first or second terminal of the first transistor element is in the second voltage state, the first transistor element is turned on when the internal node is in the first voltage state, and the first transistor element is turned off when the internal node is in the second state, due to the difference in voltage value at the one end of the first capacitance element.

### Effect of the Invention

According to the pixel circuit and display device having the above characteristics, in each of the normal display mode and the constant display mode, the pixel data can be programmed from the data signal line to the internal node using the first switch circuit. That is, in the pixel circuit, when the connection/disconnection of the switch element as the first switch circuit or the switch element and the third transistor element connected in series thereto is externally controlled, and the voltage supplied to the data signal line is controlled, the voltage held in the internal node in each pixel circuit can be controlled. Therefore, as a matter of course, the refreshing action and the polarity inverting action to the voltage held in the internal node can be performed by the programming action of the pixel data based on the external control. In this case, the pixel circuit having the above characteristics has the same function as the pixel circuit shown in FIG. 27 because the second switch circuit is not used in the programming action, and the control circuit is not used for an original purpose. By finely controlling the voltage supplied to the data signal line in the normal display mode, the multiple-tone full-color display pixel data can be programmed. In addition, in the constant display mode, when the black and while binary display (8-color display in color display using the three pixel circuits) is performed by the pixel, the voltage supplied to the data signal line takes two voltage values.

In addition, the pixel circuit of the present invention includes a sub-pixel corresponding to each color of three primary colors (RGB) serving as a minimum display unit in the case of the color display. Therefore, in the case of the color display, the pixel data is individual tone data of the three primary colors.

Furthermore, since the pixel circuit having the above characteristics has the second capacitance element, the voltage of the pixel data held in the internal node can be stabilized. In addition, since each other end of the first and second capacitance elements are mutually connected, the number of wires connected to the pixel circuit can be reduced, and the aperture ratio can be prevented from being lowered.

Here, when the second transistor element of the pixel circuit as the programming target is turned on at the time of the programming action, the first capacitance element can be used as the capacitance for holding the voltage of the internal node, which contributes stabilizing the voltage of the internal node, and especially effective when the second capacitance element is provided and each other end of the first and second capacitance elements are mutually connected.

Furthermore, according to the pixel circuit and display device having the above characteristics, by activating the second switch circuit and the control circuit in addition to the first switch circuit in the pixel circuit, the selected pixel circuits are similarly controlled in the case of the black/white binary display in the constant display mode regardless of the voltage of the pixel data held in the internal node, so that the polarity inverting action can be collectively performed. According to a conventional polarity inverting action, since it is necessary to apply different voltages to the data signal lines based on the voltage of the pixel data held in the internal node, it is necessary to store the pixel data displayed in the externally provided pixel memory for the one frame, read it, and control each data signal line individually. On the other hand, according to the pixel circuit and the display device having the above characteristics, it is not necessary to control the pixel data individually, so that the control for the polarity inverting action can be considerably simplified. Here, the polarity inverting action by the pixel circuit having the above characteristics is referred to as the “self polarity inverting action”, and the conventional polarity inverting action using the external pixel memory is referred to as the “external polarity inverting action” so as to be distinguished.

According to the self polarity inverting action in the pixel circuit having the above characteristics, two circuits such as the first switch circuit and the second switch circuit are provided as pathways which can externally supply the voltage to the internal node, the switch element (fourth transistor element) surely exists in the first switch circuit, the first and third transistor elements surely exist in the second switch circuit, and the connection/disconnection of each switch circuit can be individually controlled, so that the first switch circuit is used to reset the voltage state of the internal node to either one (first voltage state) of the voltage states regardless of the binary initial voltage state (first or second voltage state) of the internal node, the second switch circuit is connected or disconnected depending on the binary voltage state of the internal node, and the second switch circuit is connected and used to set the internal node to the other voltage state (second voltage state) only when the initial state of the voltage state is in the reset voltage state (first voltage state). That is, according to the self polarity inverting action, when the initial state is in the second voltage state, the voltage state of the internal node is changed to the first voltage state by the resetting action, but when the initial state is in the first voltage state, it is maintained in the first voltage state by the resetting action, and changed to the second voltage state by the setting action. Since the control circuit includes the second transistor element to connect the internal node and the control terminal of the first transistor element, it can set the voltage of the control terminal of the first transistor element to a different voltage corresponding to the binary initial voltage state of the internal node by controlling the voltage of the first control line connected to the control terminal of the second transistor element, so that only when the initial voltage state of the internal node is in the first voltage state, the first transistor element is turned on, the second switch circuit is connected, and the setting action can be selectively executed. In this case, when the control circuit turns off the second transistor element by controlling the voltage of the first control line before the resetting action, the voltage of the internal node after reset is separated from the one end of the first capacitance element, and the voltage state corresponding to the initial voltage state of the internal node can be held at the one end of the first capacitance element until the setting operation.

In addition, in the self polarity inverting action, the voltage of the internal node only has to be transferred from the first voltage state to the second voltage state in the setting action by the second switch circuit, so that as will be described in detail in the embodiments of the present invention, the second transistor element can be activated in a condition in which a voltage drop corresponding to a threshold voltage is not generated. Thus, it is not necessary to apply a large voltage amplitude to the control terminal of the second transistor element, and the first capacitance element only has to hold the voltage of the control terminal of the first transistor element, so that the other end of the first capacitance element may be fixed to the fixed voltage in the self polarity inverting action.

According to the pixel circuit and the display device having the above characteristics, since the binary voltage state of the internal node is transferred to another voltage state as described above, the voltage having the inverted polarity and the same absolute value as the voltage originally applied to the unit liquid crystal display element can be applied to the unit liquid crystal display element in the same pixel circuit by appropriately changing the voltage of the opposite electrode (common electrode) which is not connected to the internal node of the unit liquid crystal display element. For example, when the voltage of the opposite electrode lies exactly between the first voltage state and the second voltage state, it is not necessary to change the voltage of the opposite electrode, but when it is close to the first voltage state or the second voltage state, such as when it is one voltage of the first voltage state and the second voltage state, it needs to be changed to the other voltage. This change of the voltage of the opposite electrode is preferably performed after the second transistor element has been turned off and before the resetting action. Since the internal node and the opposite electrode are capacitance-coupled through the unit liquid crystal display element, the voltage state held at the one end of the first capacitance element before the second transistor element is turned off, and the voltage state of the internal node after reset are prevented from being affected by the voltage change of the opposite electrode.

In addition, according to the pixel circuit and the display device having the above characteristics, in both of the normal display and the constant display modes, the normal programming action, the refreshing action and the polarity inverting action (external polarity inverting action) by the programming action can be performed, and the self polarity inverting action can be collectively performed on the plurality of the selected pixel circuits in totally the same manner regardless of the voltage of the pixel data held in the internal node. Therefore, the polarity can be inverted in all of the pixel circuits in the one frame at the same time by the one self polarity inverting action, so that the number of times to drive the data signal line can be considerably reduced compared with the conventional external polarity inverting action executed by the scanning signal line, so that the power consumption can be considerably reduced.

Moreover, the pixel circuit having the above characteristics can be configured by adding the second switch circuit and control circuit having the simple circuit configuration composed of the three transistor elements and one capacitance element, without separately providing the memory part such as the SRAM, so that the aperture ratio per pixel circuit can be high compared with the configuration having the memory part having the complicated circuit configuration such as the SRAM.

In addition, in the pixel circuit having the above characteristics, the circuit configuration is deformable in the first switch circuit and the second switch circuit. As for the first switch circuit, when it is composed of the switch element only, the circuit configuration is simplest. The first switch circuit may include the series circuit composed of the switch element and the third transistor element. However, in the latter case, it is necessary to control the third transistor element similarly to the scanning signal line, in the programming action performed by the scanning signal line.

Furthermore, the voltage supply line may be the independent wire, but when it also serves as the first control line, the fixed voltage line, or the data signal line, the number of wires to be connected to the pixel circuit can be reduced and the aperture ratio can be prevented from being lowered.

### BRIEF DESCRIPTION OF THE DRAWINGS

FIG. 1 is a block diagram showing one example of a schematic configuration of a display device according to the present invention.

FIG. 2 is a schematic cross-sectional structure view showing a part of a liquid crystal display device.

FIG. 3 is a block diagram showing one example of a schematic configuration of a display device according to the present invention.

FIG. 4 is a circuit diagram showing a basic circuit configuration of a pixel circuit according to the present invention.

FIG. 5 is a circuit diagram showing a first type circuit configuration example of a pixel circuit according to the present invention.

FIG. 6 is a circuit diagram showing a second type circuit configuration example of a pixel circuit according to the present invention.

FIG. 7 is a circuit diagram showing a third type circuit configuration example of a pixel circuit according to the present invention.

FIG. 8 is a circuit diagram showing a fourth type circuit configuration example of a pixel circuit according to the present invention.

FIG. 9 is a circuit diagram showing another first type circuit configuration example of a pixel circuit according to the present invention.

FIG. 10 is a circuit diagram showing another first type circuit configuration example of a pixel circuit according to the present invention.

FIG. 11 is a circuit diagram showing a fifth type circuit configuration example of a pixel circuit according to the present invention.

FIG. 12 is a circuit diagram showing a sixth type circuit configuration example of a pixel circuit according to the present invention.

FIG. 13 is a circuit diagram showing another sixth type circuit configuration example of a pixel circuit according to the present invention.

FIG. 14 is a circuit diagram showing another fifth type circuit configuration example of a pixel circuit according to the present invention.

FIG. 15 is a timing chart of a self polarity inverting action in the first type pixel circuit.

FIG. 16 is a timing chart of a self polarity inverting action in the second type pixel circuit.

FIG. 17 is a timing chart of a self polarity inverting action in the third type pixel circuit.

FIG. 18 is a timing chart of a self polarity inverting action in the fourth type pixel circuit.

FIG. 19 is a timing chart of a self polarity inverting action in the fifth type pixel circuit.

FIG. 20 is a timing chart of a self polarity inverting action in the sixth type pixel circuit.

FIG. 21 is a timing chart of a programming action in a constant display mode in the first type pixel circuit.

FIG. 22 is a timing chart of a programming action in the constant display mode in the fifth type pixel circuit.

FIG. 23 is a timing chart of a programming action in the constant display mode in the sixth type pixel circuit.

FIG. 24 is a flowchart showing a procedure to execute the programming action and the self polarity inverting action in the constant display mode.

FIG. 25 is a timing chart of the programming action in a normal display mode in the first type pixel circuit.

FIG. 26 is a circuit diagram showing another embodiment of the basic circuit configuration of the pixel circuit according to the present invention.

FIG. 27 is an equivalent circuit diagram of a pixel circuit of a general active matrix type liquid crystal display device.

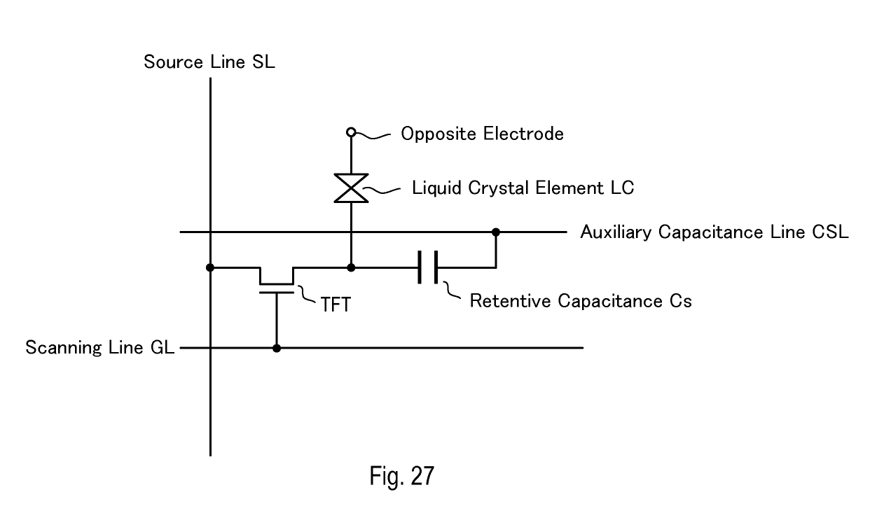

FIG. 28 is a block diagram showing a circuit arrangement example of the active matrix type liquid crystal display device having m×n pixels.

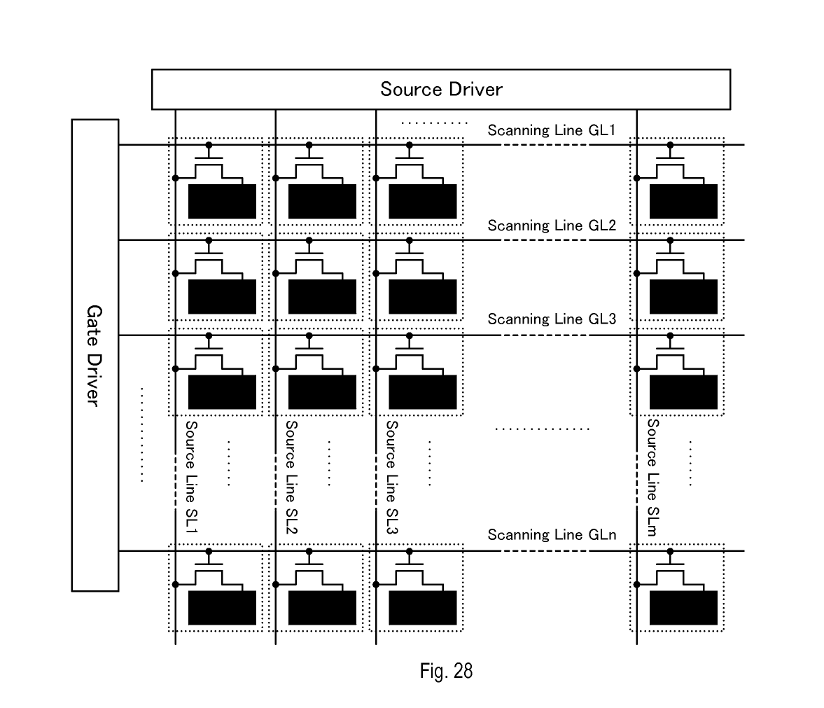

### MODE FOR CARRYING OUT THE INVENTION

Each embodiment of a pixel circuit and a display device according to the present invention will be descried with reference to the drawings.

### First Embodiment

According to a first embodiment, a description will be made of a display device of the present invention (hereinafter, simply referred to as the display device), and a circuit configuration of a pixel circuit of the present invention (hereinafter, simply referred to as the pixel circuit).

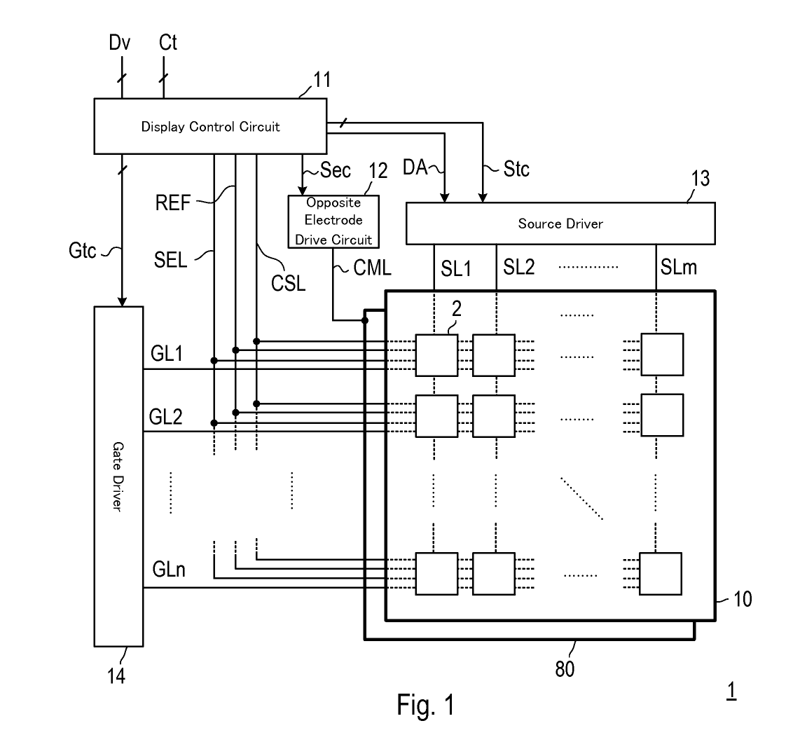

FIG. 1 shows a schematic configuration of a display device 1. The display device 1 includes an active matrix substrate 10, an opposite electrode 80, a display control circuit 11, an opposite electrode drive circuit 12, a source driver 13, a gate driver 14, and various kinds of signal lines which will be described below. On the active matrix substrate 10, pixel circuits 2 are arranged in row and column directions, whereby a pixel circuit array is formed. In addition, in FIG. 1, to avoid complication in the drawing, the pixel circuits 2 are shown in blocks. In addition, in FIG. 1, to clearly show the various kinds of signal lines formed on the active matrix substrate 10, the active matrix substrate 10 is shown on the upper side of the opposite electrode 80 for convenience.

According to this embodiment, the display device 1 can display a screen in two display modes such as a normal display mode and a constant display mode with the same pixel circuit 2. As for the normal display mode, a moving picture or a still picture is displayed in full color, and a transmissive type liquid crystal display having a backlight is used. Meanwhile, as for the constant display mode in this embodiment, two tones (black and white) are displayed by the pixel circuit, and three adjacent pixel circuits 2 are allocated to three primary colors (R, G, B) to display 8 colors. Moreover, in the constant display mode, by combining several sets of the adjacent three pixel circuits, the number of display colors can be increased by an area coverage modulation. In addition, the constant display mode in this embodiment can be used in each of a transmissive type liquid crystal display and a reflective liquid type crystal display.

In the following description, for convenience, a smallest display unit corresponding to one pixel circuit 2 is referred to as the “pixel”, and “pixel data” to be programmed in each pixel circuit is tone data of each color in the case of the color display by the three primary colors (R, G, B). In addition, when a color display includes black and white brightness data in addition to the three primary colors, the brightness data is included in the pixel data.

As will be described below, the display device 1 is characterized in that it can execute the “self polarity inverting action” in the constant display mode, so that power consumption can be extremely reduced compared to the conventional one which executes the “external polarity inverting action”, and as a matter of course, it can be applied to a liquid crystal display using only the constant display mode without combining the normal display mode with the constant display mode.

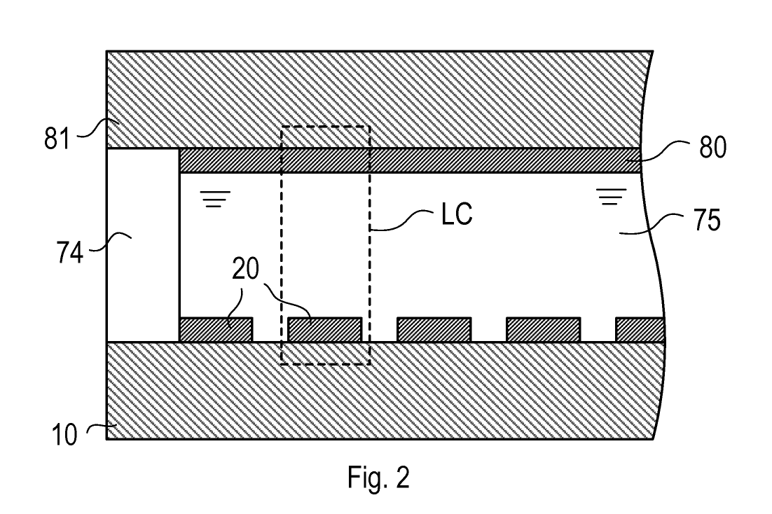

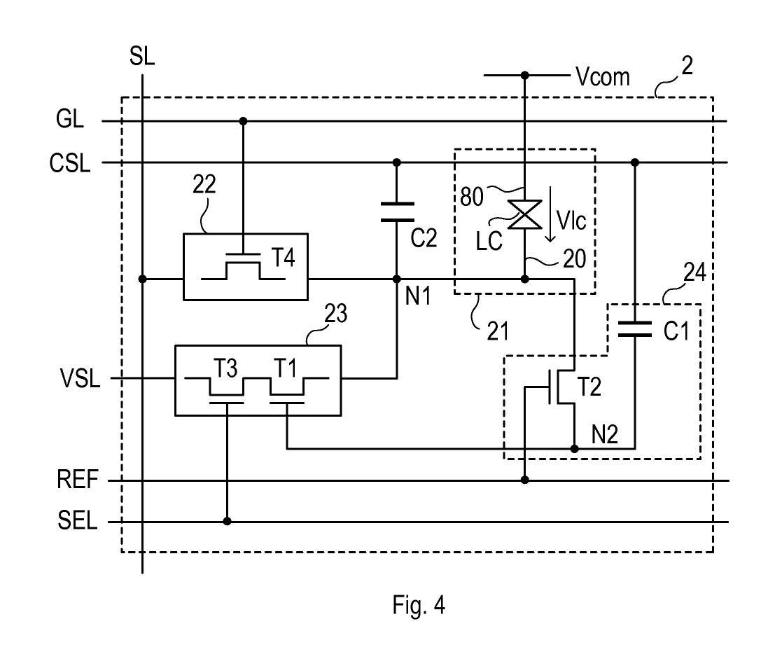

FIG. 2 is a schematic cross-sectional structure view showing a relationship between the active matrix substrate 10 and the opposite electrode 80, and shows a structure of a display element part 21 (refer to FIG. 4) serving as a component of the pixel circuit 2. The active matrix substrate 10 is a light transmissive transparent substrate, and formed of a material such as glass or plastic. As shown in FIG. 1, the pixel circuit 2 is formed on the active matrix substrate 10 together with the signal lines. FIG. 2 shows a pixel electrode 20 as a representative component of the pixel circuit 2. The pixel electrode 20 is formed of a light transmissive transparent conductive material such as ITO (indium tin oxide).

So as to be opposed to the active matrix substrate 10, a light transmissive opposite substrate 81 is arranged, and a liquid crystal layer 75 is held between these substrates. A polarization plate (not shown) is attached onto an outer surface of each substrate.

The liquid crystal layer 75 is sealed by a seal material 74 in peripheral parts of both substrates. On the opposite substrate 81, the opposite electrode 80 is formed of a light transmissive transparent conductive material such as ITO so as to be opposed to the pixel electrode 20. The opposite electrode 80 is formed as a single film and spread almost all over the opposite substrate 81. Here, a unit liquid crystal display element LC (refer to FIG. 4) is composed of the pixel electrode 20, the opposite electrode 80, and the liquid crystal layer 75 sandwiched between them.

In addition, a backlight device (not shown) is arranged on the back surface side of the active matrix substrate 10, and it can emit light in a direction from the active matrix substrate 10 toward the opposite substrate 81.

As shown in FIG. 1, the plurality of signal lines are formed on the active matrix substrate 10 in vertical and horizontal directions. Thus, the pixel circuits 2 are formed in a matrix at intersection points of m source lines (SL1, SL2, . . . , SLm) extending in the vertical direction (column direction) and n gate lines (GL1, GL2, . . . , GLn) extending in the horizontal direction (row direction). In addition, each of m and n is a natural number of 2 or more. Voltages based on an image to be displayed are applied from the source driver 13 and the gate driver 14 to the pixel electrode 20 formed in each pixel circuit 2 through the source line SL and the gate line GL, respectively. In addition, for convenience, the source lines (SL1, SL2, . . . , SLm) are collectively referred to as the source line SL, and the gate lines (GL1, GL2, . . . , GLn) are collectively referred to as the gate line GL.

Here, the source line SL corresponds to a “data signal line”, and the gate line GL corresponds to a “scanning signal line”. The source driver 13 corresponds to a “data signal line drive circuit”, the gate driver 14 corresponds to a “scanning signal line drive circuit”, the opposite electrode drive circuit 12 corresponds to an “opposite electrode voltage supply circuit”, and a part of the display control circuit 11 corresponds to a “control line drive circuit”.

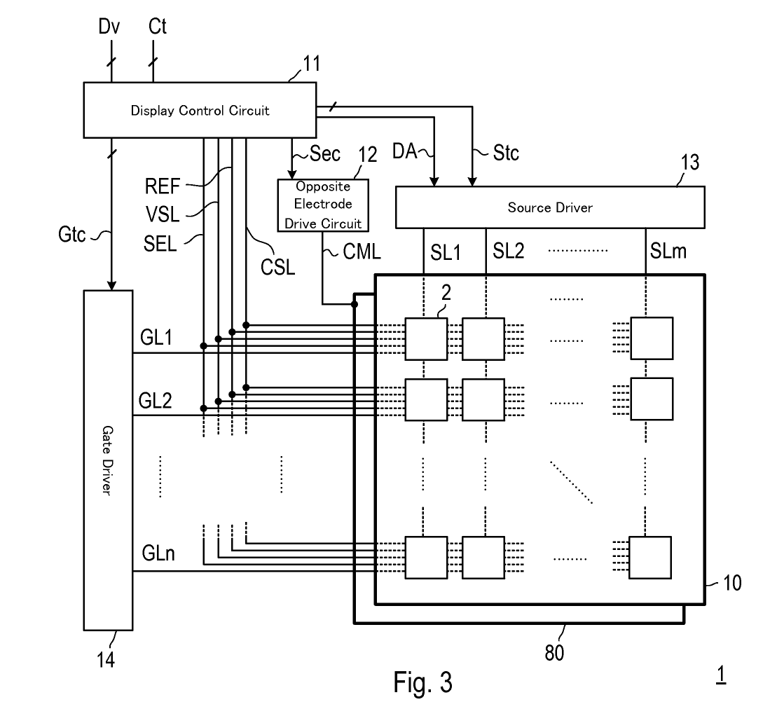

According to this embodiment, the signal lines to drive the pixel circuit 2 include a reference line REF, a selection line SEL, an auxiliary capacitance line CSL, and a voltage supply line VSL other than the source line SL and the gate line GL. According to the configuration shown in FIG. 1, the voltage supply line VSL also serves as the source line SL, the auxiliary capacitance line CSL, or the reference line REF. The voltage supply line VSL can be an independent signal line as shown in FIG. 3, but when it also serves as another signal line, the number of the signal lines to be arranged on the active matrix substrate 10 can be reduced, and an aperture ratio of each pixel can be improved.

The reference line REF and the selection line SEL correspond to a “first control line” and a “second control line”, respectively and are driven by the display control circuit 11. The auxiliary capacitance line CSL corresponds to a “fixed voltage line (third control line)”, and is driven by the display control circuit 11, for example. According to the configuration shown in FIG. 1, since the voltage supply line VSL also serves as the source line SL, or the reference liner REF, it is driven by the source driver 13 or the display control circuit 11.

In addition, according to the configuration shown in FIGS. 1 and 3, each of the reference line REF, the selection line SEL, and the auxiliary capacitance line CLS is provided in each row so as to extend in the row direction, and these lines are mutually connected into one line in a peripheral part of the pixel circuit array, but they may be individually driven and a common voltage may be applied thereto based on the operation mode. In addition, depending on a type of the circuit configuration of the pixel circuit 2 to be described below, the reference liner REF, the selection line SEL, and the auxiliary capacitance line CSL may be partially or all provided in each column so as to extend in the column direction. Basically, each of the reference line REF, the selection line SEL, and the auxiliary capacitance line CSL is shared by the plurality of pixel circuits 2.

The display control circuit 11 controls a programming action in each of the normal display mode and the constant display mode which will be described below, and the self polarity inverting action in the constant display mode. At the time of the programming action, the display control circuit 11 receives a data signal Dv and a timing signal Ct showing the image to be displayed from an external signal source, and based on the signals Dv and Ct, generates a digital image signal DA and a data side timing control signal Stc to be applied to the source driver 13, a scan side timing control signal Gtc to be applied to the gate driver 14, an opposite voltage control signal Sec to be applied to the opposite electrode drive circuit 12 as the signals to display the image on the display element part 21 of the pixel circuit array, and a signal voltage to be applied to each of the reference line REF, the selection line SEL, the auxiliary capacitance line CSL, and the voltage supply line VSL. In addition, it is also preferable that the display control circuit 11 is partially or all formed in the source driver 13 or the gate driver 14.

The source driver 13 is controlled by the display control circuit 11, and applies a source signal having a predetermined timing and a predetermined voltage amplitude to each source line SL at the time of programming action and the self polarity inverting action. At the time of the programming action, based on the digital image signal DA and the data side timing control signal Stc, the source driver 13 generates voltages which correspond to pixel values for one display line expressed by the digital signal DA and are appropriate to a voltage level of the opposite voltage Vcom, as the source signals Sc1, Sc2, . . . , Scm every one horizontal period (referred to as the “one H period” occasionally). The voltage is a multiple-tone analog voltage in the normal display mode, and a 2-tone (binary) voltage in the constant display mode. Thus, these source signals are applied to the corresponding source line SL1, SL2, . . . , SLm. In addition, at the time of the self polarity inverting action, the source driver 13 is controlled by the display control circuit 11 and applies the same voltage at the same timing to all of the source line SL connected to the target pixel circuits 2 (which will be described in detail below).

The gate driver 14 is controlled by the display control circuit 11, and applies a gate signal having a predetermined timing and a predetermined voltage amplitude to each gate line GL at the time of the programming action and at the time of the self polarity inverting action. At the time of the programming action, based on the scan side timing control signal Gtc, the gate driver 14 sequentially selects the gate lines GL1, GL2, . . . , GLn almost every one horizontal period, in each frame period of the digital image signal DA, in order to program the source signals Sc1, Sc2, . . . , Scm in the pixel circuits 2. In addition, at the time of the self polarity inverting action, the gate driver 14 is controlled by the display control circuit 11, and applies the same voltage at the same timing to all of the gate lines GL connected to the target pixel circuits 2 (which will be described in detail below). In addition, the gate driver 14 may be formed on the active matrix substrate 10 similar to the pixel circuit 2.

The opposite electrode drive circuit 12 applies an opposite voltage Vcom to the opposite electrode 80 through an opposite electrode wire CML. According to this embodiment, the opposite electrode drive circuit 12 alternately switches the opposite voltage Vcom between high level (5V) and predetermined low level (0V) and outputs it in the normal display mode and the constant display mode. Thus, the action to drive the opposite electrode 80 while switching the opposite voltage Vcom between high level and low level is referred to as an “opposite AC driving”. In addition, according to the “opposite AC driving” in the normal display mode, the opposite voltage Vcom is switched between high level and low level every one horizontal period and every one frame period. That is, in a certain frame period, the voltage polarity between the opposite electrode 80 and the pixel electrode 20 is changed between two sequential horizontal periods, and as far as the same one horizontal period is concerned, the voltage polarity between the opposite electrode 80 and the pixel electrode 20 is changed between the two sequential frame periods. In addition, in the constant display mode, the same voltage level is maintained during the one frame period, but the voltage polarity between the opposite electrode 80 and the pixel electrode 20 is changed between the two sequential programming actions.

After the voltage having the same polarity has been continuously applied between the opposite electrode 80 and the pixel electrode 20, the display screen is burnt (surface burning), so that the polarity inverting action is needed, and by employing the “opposite AC driving”, a voltage amplitude applied to the pixel electrode 20 can be reduced in the polarity inverting action.

Next, the configuration of the pixel circuit 2 will be described with reference to FIGS. 4 to 14. FIG. 4 shows a basic circuit configuration of the pixel circuit 2 in the present invention. In common with all the circuit configurations, the pixel circuit 2 is composed of the display element part 21 including the unit liquid crystal display element LC, an auxiliary capacitance element C2 (corresponding to a second capacitance element), a first switch circuit 22, a second switch circuit 23, and a control circuit 24. In addition, the basic circuit configuration shown in FIG. 4 is a common circuit configuration including first to sixth type basic circuit configurations which will be described below. Since the unit liquid crystal display element LC has been described with reference to FIG. 2, its description is omitted.

Each one end of the first switch circuit 22, the second switch circuit 23, and the control circuit 24 is connected to the pixel electrode 20, and an internal node N1 is formed. The internal node N1 holds a voltage of the pixel data supplied from the source line SL at the time of the programming action. The auxiliary capacitance element C2 has one end connected to the internal node N1, and the other end connected to the auxiliary capacitance line CSL. The auxiliary capacitance element C2 is additionally provided so that the internal node N1 can stably hold the voltage of the pixel data.

The first switch circuit 22 has the other end connected to the source line SL, and includes at least a transistor T4 (corresponding to a fourth transistor element), and a control terminal of the transistor T4 is connected to the gate line GL. When at least the transistor T4 is off, the first switch circuit 22 is in an unconnected state, so that the connection between the source line SL and the internal node N1 is cut.

The second switch circuit 23 has the other end connected to the voltage supply line VSL, and includes a series circuit composed of a transistor T1 (corresponding to a first transistor element) and a transistor T3 (corresponding to a third transistor element), in which a control terminal of the transistor T1 is connected to an output node N2, and a control terminal of the transistor T3 is connected to the selection line SEL. When both of the transistor T1 and the transistor T3 are on, the second switch circuit 21 is in a connected state, and the voltage supply line VSL and the internal node N1 are connected.

The control circuit 24 include a series circuit composed of a transistor T2 (corresponding to a second transistor element) and a first capacitance element C1, in which a first terminal of the transistor T2 is connected to the internal node N1, a second terminal of the transistor T2 is connected to one end of the first capacitance element C1, a control terminal of the transistor T2 is connected to the reference line REF, and the other end of the first capacitance element C1 is connected to the auxiliary capacitance line CSL. A connecting point between the second terminal of the transistor T2 and the one end of the first capacitance element C1 forms the output node N2, and the output node N2 is configured such that it holds a voltage corresponding to a voltage level of the internal node N1 when the transistor T2 is on, and it holds an initial hold voltage when the transistor T2 is off even after the voltage level of the internal node N1 has been changed, and by this hold voltage, the transistor T1 of the second switch circuit 23 is turned on or off.

Each of the four kinds of transistors T1 to T4 is a thin-film transistor such as a polycrystalline silicon TFT or an amorphous silicon TFT formed on the active matrix substrate 10, and one of the first and second terminals serves as a drain electrode, the other serves as a source electrode, and the control terminal serves as a gate electrode. In addition, each of the transistors T1 to T4 may include a single transistor, but when a leak current is strongly required to be suppressed at the time of off, a plurality of transistors may be connected in series and their control terminals may be used in common. In addition, in the following explanation for the action of the pixel circuit 2, it is assumed that each of the transistors T1 to T4 is an N-channel type polycrystalline silicon TFT and a threshold voltage is 2 V.

The pixel circuit 2 may have various circuit configurations having the same function by combining the following patterns such as two configuration patterns in which the first switch circuit 22 consists of the transistor T4, and in which it includes a series circuit composed of the transistor T3 in the second switch circuit 23 or another transistor T5 whose control terminal is mutually connected to the control terminal of the transistor T3, and the transistor T4; four configuration patterns in which the voltage supply line VSL also serves as the source line SL, also serves as the reference line REF, also serves as the auxiliary capacitance line CSL, and is independently provided; and several variation patterns in which the arrangement positions of the transistor T3 are varied in the second switch circuit 23 or the first switch circuit 22. In addition, the transistor T5 has the same characteristics as that of the transistor T3, its control terminal is connected to the selection line SEL, and it is turned on/off by the selection line SEL, so that the first switch circuit 22 including the series circuit composed of the transistor T3 and the transistor T4 is equivalent to the first switch circuit 22 including the series circuit composed of the transistor T5 and the transistor T4. In the following description, for convenience, the transistor T3 and the transistor T5 in the first switch circuit 22 are not discriminated and collectively referred to as the transistor T3.

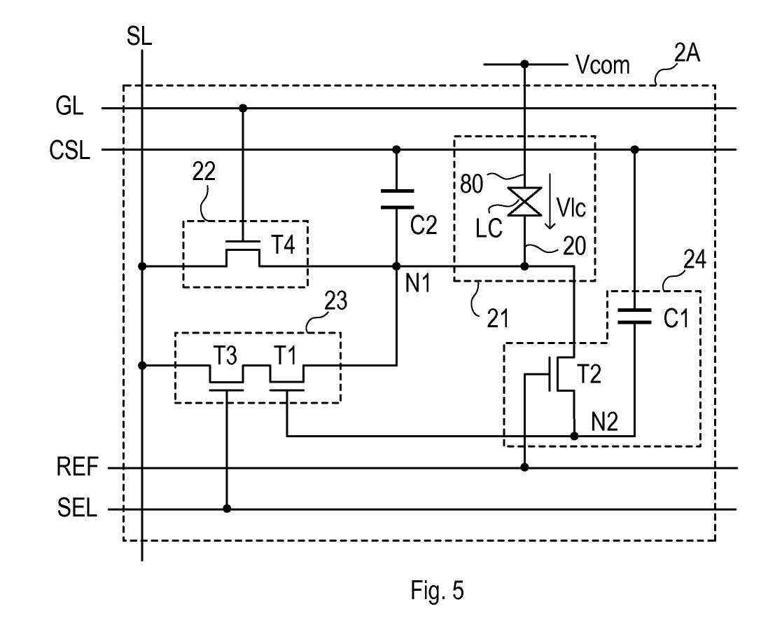

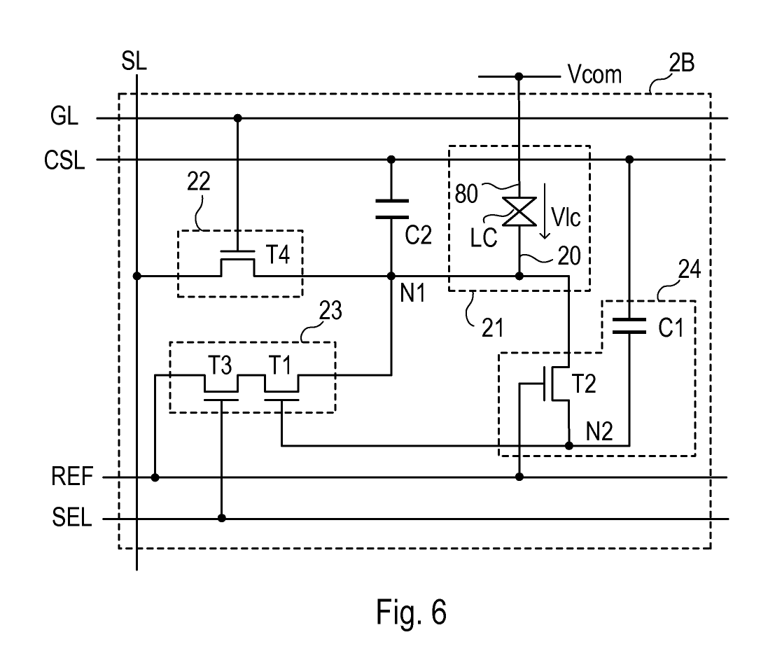

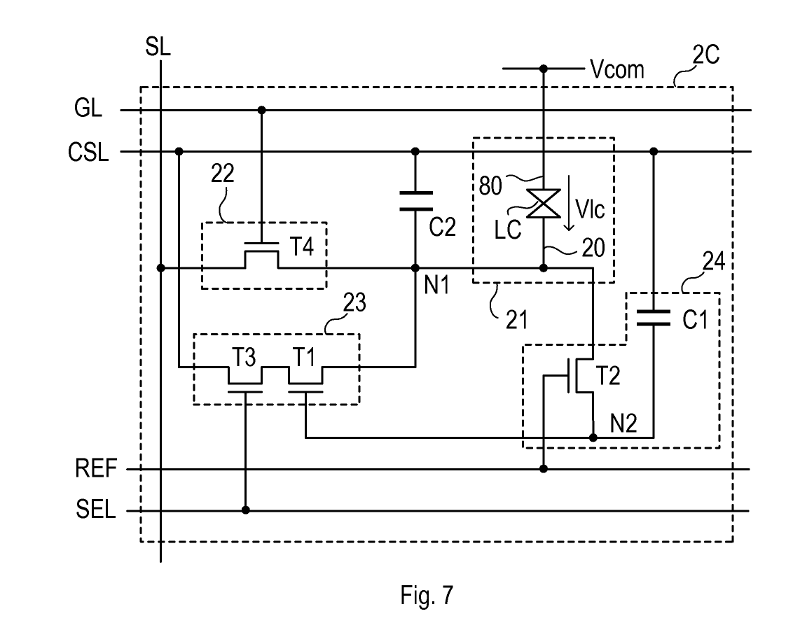

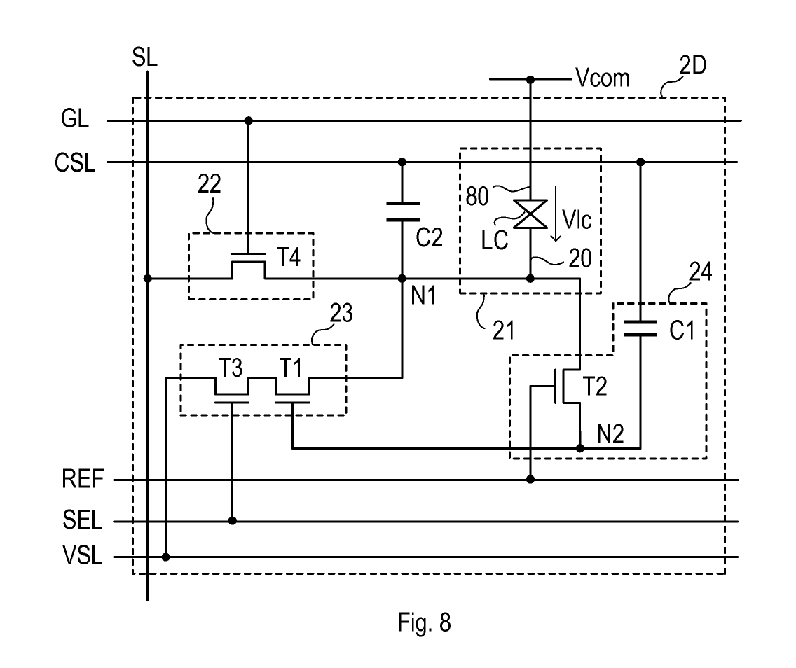

In the case where the first switch circuit 22 consists of the transistor T4, the first to fourth type basic circuit configurations shown in FIGS. 5 to 8, are provided based on the configuration of the voltage supply line VSL. According to a pixel circuit 2A having the first type basic circuit configuration shown in FIG. 5, the voltage supply line VSL also serves as the source line SL, and according to a pixel circuit 2B having the second type basic circuit configuration shown in FIG. 6, the voltage supply line VSL also serves as the reference line REF, and the reference line REF extends in the lateral direction (row direction) so as to be parallel to the gate line GL, as one example, but it may extend in the vertical direction (column direction) so as to be parallel to the source line SL. According to a pixel circuit 2C having the third type basic circuit configuration shown in FIG. 7, the voltage supply line VSL also serves as the auxiliary capacitance line CSL, and the auxiliary capacitance line CSL extends in the lateral direction (row direction) so as to be parallel to the gate line GL, as one example, but it may extend in the vertical direction (column direction) so as to be parallel to the source line SL. According to a pixel circuit 2D having the fourth type basic circuit configuration shown in FIG. 8, the voltage supply line VSL is the independent signal line, and the voltage supply line VSL extends in the lateral direction (row direction) so as to be parallel to the gate line GL, as one example, but it may extend in the vertical direction (column direction) so as to be parallel to the source line SL.

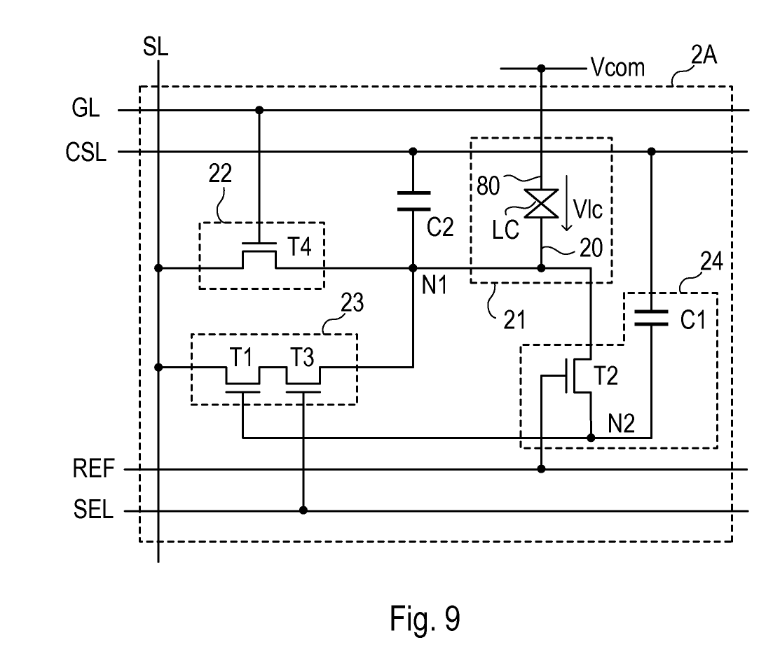

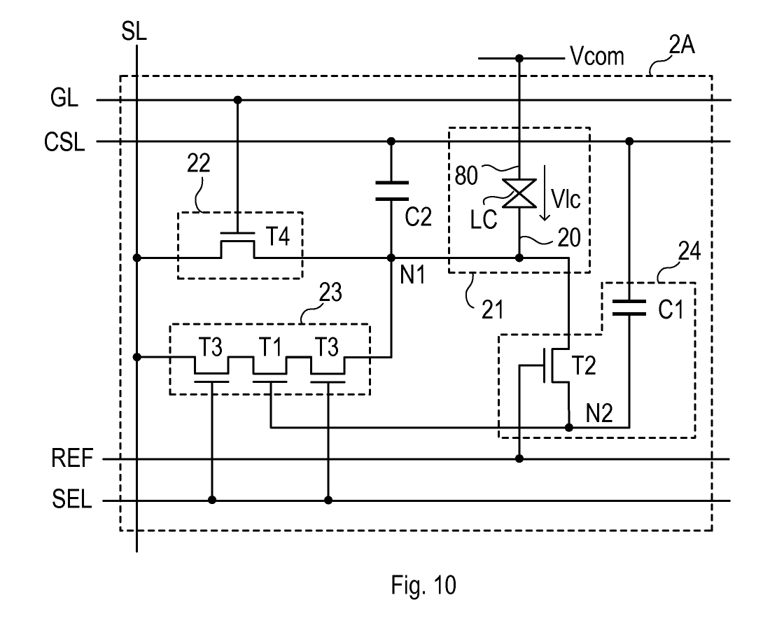

According to the first to fourth type basic circuit configurations shown in FIGS. 5 to 8, the second switch circuit 23 includes the series circuit composed of the transistor T1 and the transistor T3, in which the first terminal of the transistor T1 is connected to the internal node N1, the second terminal of the transistor T1 is connected to the first terminal of the transistor T3, the second terminal of the transistor T3 is connected to the voltage supply line VSL (the source line SL, the reference line REF, or the auxiliary capacitance line CSL) as one example. However, the arrangement of the transistor T1 and the transistor T3 in the series circuit may be exchanged, or the transistor T1 may be sandwiched between the two transistors T3. These two variation circuit configuration examples are shown in FIGS. 9 and 10 based on the first type pixel circuit 2A in which the source line SL also serves as the voltage supply line VSL.

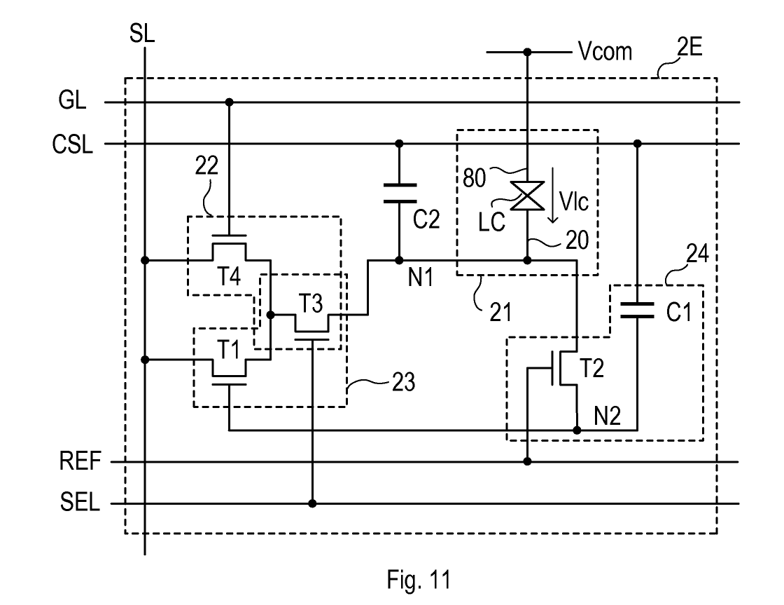

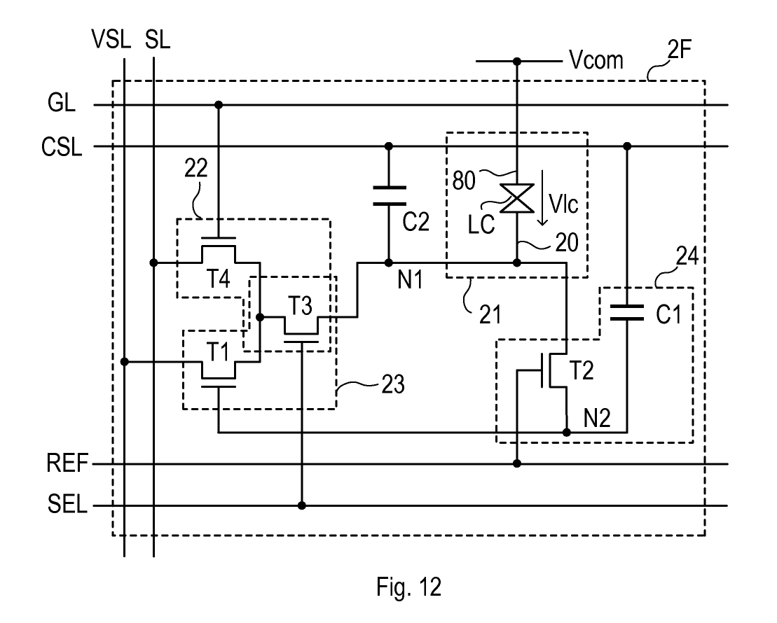

When the first switch circuit 22 includes the series circuit composed of the transistor T4 and the transistor T3, the fifth and sixth basic circuit configurations shown in FIGS. 11 and 12 are provided based on the configurations of the voltage supply line VSL. According to a pixel circuit 2E having the fifth type basic circuit configuration shown in FIG. 11, the source line SL also serves as the voltage supply line VSL. According to a pixel circuit 2F having the sixth type basic circuit configuration shown in FIG. 12, the voltage supply line VSL is the independent signal line, and the voltage supply line VSL extends in the vertical direction (column direction) so as to be parallel to the source line SL, as one example, but it may extend in the lateral direction (row direction) so as to be parallel to the gate line GL.

In the case where the first switch circuit 22 includes the series circuit composed of the transistor T4 and the transistor T3, the configuration in which the reference line REF also serves as the voltage supply line VSL cannot be employed because different voltage application conditions are required for the voltage supply line VSL and the reference line REF in the self polarity inverting action which will be described below (more specifically, 5 V is applied to the voltage supply line VSL and 0 V is applied to the reference line REF, in a fourth phase).

In addition, in the case where the first switch circuit 22 includes the series circuit composed of the transistor T4 and the transistor T3, the configuration in which the auxiliary capacitance line CSL also serves as the voltage supply line VSL cannot be employed because the voltage of the auxiliary capacitance line CSL serving as the voltage supply line VSL needs to be changed in the middle of the self polarity inverting action which will be described below (more specifically, 5 V in the fourth phase, and 0 V in a sixth phase), so that capacitance coupling through the auxiliary capacitance element C2 and the first capacitance element C1 interferes with the voltage of the internal node N1 in the middle of the self polarity inverting action.

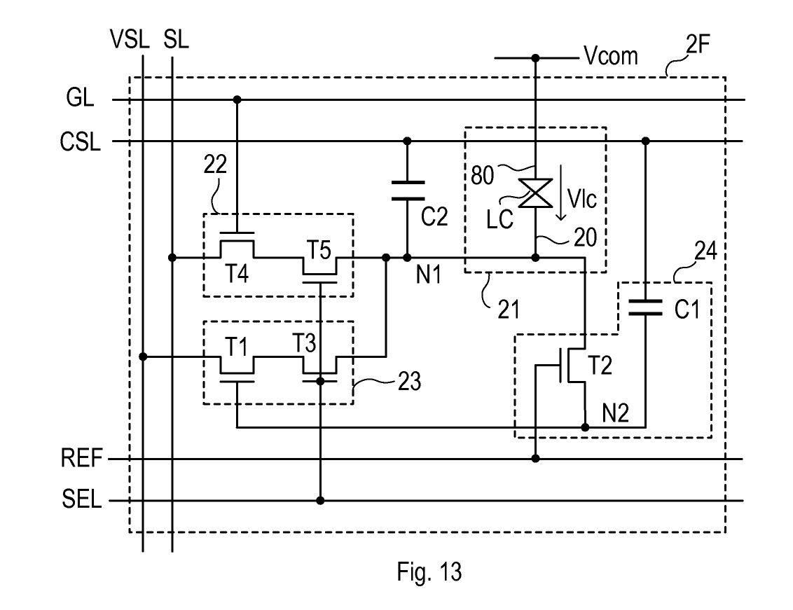

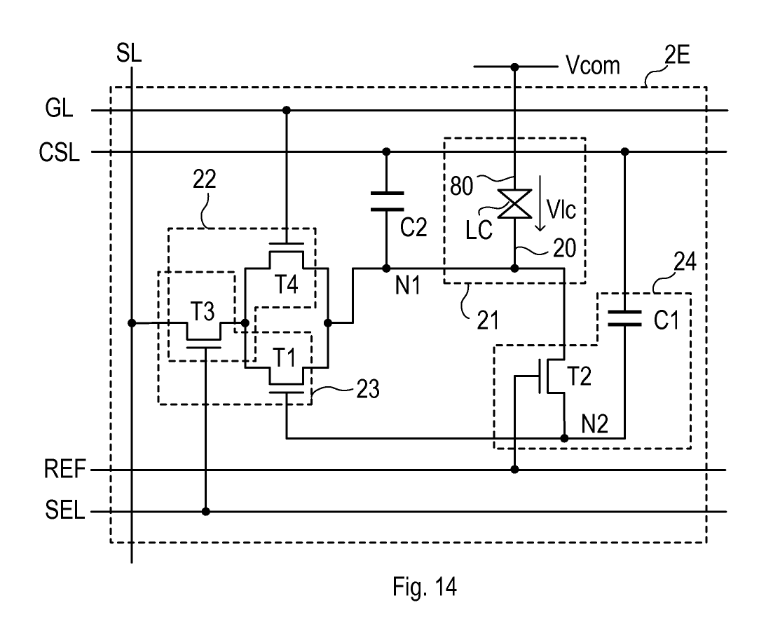

According to the fifth and sixth type basic circuit configurations shown in FIGS. 11 and 12, the first switch circuit 22 includes the series circuit composed of the transistor T4 and the transistor T3, the second switch circuit 23 includes the series circuit composed of the transistor T1 and the transistor T3, in which the first terminal of the transistor T3 is connected to the internal node N1, the second terminal of the transistor T3 is connected to the first terminal of the transistor T1 and the first terminal of the transistor T4, the second terminal of the transistor T4 is connected to the source line SL, and the second terminal of the transistor T1 is connected to the source line SL or the voltage supply line VSL. According to the circuit configuration examples shown in FIGS. 11 and 12, the first switch circuit 22 and the second switch circuit 23 shares the same transistor T3, but as another configuration, the transistor T3 may be divided into two, and the first switch circuit 22 and the second switch circuit 23 each may have the transistor T3. FIG. 13 shows this variation circuit configuration example, based on the sixth type pixel circuit 2F in which the voltage supply line VSL is the independent signal line. In the variation circuit configuration example shown in FIG. 13, similar to the circuit configurations shown in FIGS. 9 and 10, the arrangement of the transistor T1 and the transistor T3 in the series circuit may be exchanged in the second switch circuit 23, or the transistor T1 may be sandwiched between the two transistors T3. Furthermore, in the variation circuit configuration example shown in FIG. 13, the arrangement of the transistor T3 and the transistor T4 in the series circuit may be exchanged in the first switch circuit 22. Moreover, in the pixel circuit 2E of the fifth type basic circuit configuration shown in FIG. 11, as shown in FIG. 14, the arrangement of the transistor T4 and the transistor T3 in the series circuit may be exchanged in the first switch circuit 22, and the arrangement of the transistor T1 and the transistor T3 in the series circuit may be exchanged in the second switch circuit 23.

### Second Embodiment

According to a second embodiment, a description will be made of the self polarity inverting action in the pixel circuits 2A to 2F of the first to sixth type circuit configurations shown in FIGS. 5 to 8, 11, and 12 with reference to the drawings with respect to each type. In addition, the self polarity inverting action is the action in the constant display mode, and the first switch circuit 22, the second switch circuits 23, and the control circuits 24 in the pixel circuits 2 are activated in a predetermined sequence, and the polarity of a liquid crystal voltage Vlc applied between the pixel electrodes 20 and the opposite electrodes 80 is inverted collectively at the same time with its absolute value maintained. Therefore, the same voltage is applied at the same time to all of the gate line GL, the source line SL, the selection line SEL, the reference line REF, the auxiliary capacitance line CSL, the voltage supply line VSL, and the opposite electrode 80 connected to the pixel circuit 2 which is the target of the self polarity inverting action. The timing of the voltage application is controlled by the display control circuit 11 shown in FIG. 1, and the voltage is individually applied by the display control circuit 11, the opposite electrode drive circuit 12, the source driver 13, and the gate driver 14. The self polarity inverting action is an operation specific to the present invention performed by the pixel circuits 2A to 2F, and can considerably reduce power consumption compared to the conventional “external polarity inverting action”. In addition, the term “at the same time” in the term “collectively at the same time” means the “same time” having a time width of a series of self polarity inverting action.

The liquid crystal voltage Vlc is expressed by the opposite voltage Vcom of the opposite electrode 80, and a pixel voltage V20 held in the pixel electrode 20 as a formula 2 provided below.

Vlc=V20−Vcom (Formula 2)

In addition, since the 2-tone (binary) pixel data is held in each pixel circuit in the constant display mode in this embodiment, the pixel voltage V20 held in the pixel electrode 20 (internal node N1) takes two voltage states such as a first voltage state and a second voltage state. In this embodiment, similar to the above opposite voltage Vcom, a description will be made assuming that the first voltage state is high level (5 V), and the second voltage state is low level (0 V). Therefore, the liquid crystal voltage Vlc is +5 V or −5 V when the pixel voltage V20 and the opposite voltage Vcom are different, and it is 0V when the pixel voltage V20 and the opposite voltage Vcom are the same. Therefore, by the self polarity inverting action, the liquid crystal voltage Vlc=+5 V becomes the liquid crystal voltage Vlc=−5 V in the pixel circuit 2, the liquid crystal voltage Vlc=−5 V becomes the liquid crystal voltage Vlc=+5 V in the pixel circuit 2, and the liquid crystal voltage Vlc=0V is maintained as liquid crystal voltage Vlc=0 V in the pixel circuit 2. More specifically, by the self polarity inverting action, the opposite voltage Vcom is transferred from high level (5 V) to low level (0 V), or from low level (0 V) to high level (5 V), and the pixel voltage V20 is transferred from high level (5 V) to low level (0 V) or from low level (0 V) to high level (5 V). A description will be made of a case (case A) in which the pixel voltage V20 is transferred from high level (5 V) to low level (0 V) and a case (case B) in which it is transferred from low level (0 V) to high level (5 V), in the case where the opposite voltage Vcom is transferred from low level (0 V) to high level (5 V).

### <1> First Type Self Polarity Inverting Action

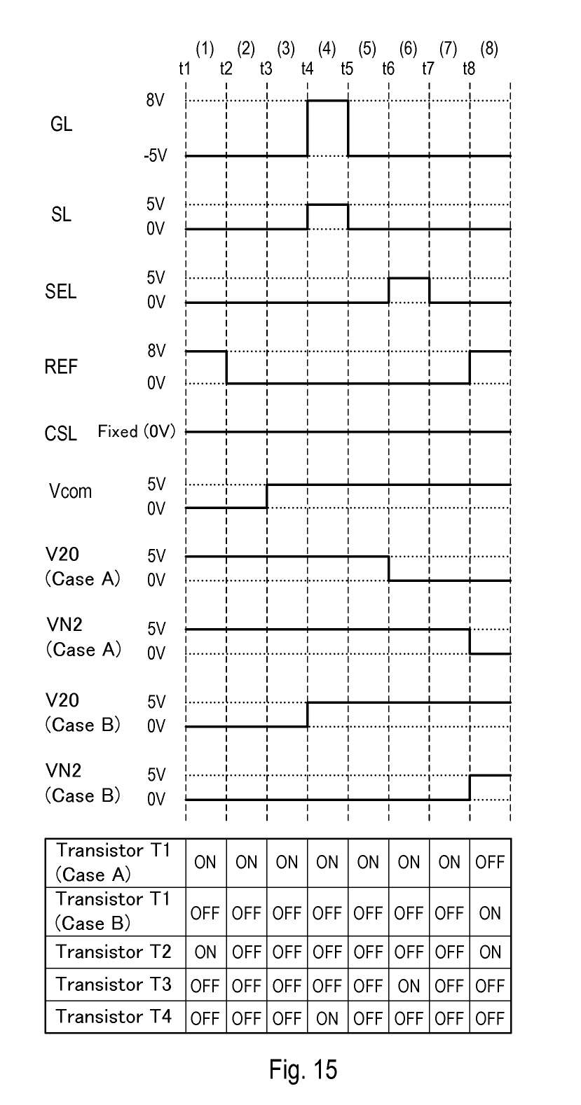

FIG. 15 show a timing chart of a first type self polarity inverting action. As shown in FIG. 15, the self polarity inverting action is divided into 8 phases (first to eighth phases). Start times of the phases are assumed at t1, t2, . . . , t8. FIG. 15 shows voltage waveforms of the gate line GL, the source line SL, the selection line SEL, the reference line REF, and the auxiliary capacitance line CSL connected to the pixel circuit 2A serving as the target of the self polarity inverting action, and a voltage waveform of the opposite voltage Vcom. In addition, in this embodiment, the pixel circuits in the pixel circuit array are all the target of the self polarity inverting action. In addition, FIG. 15 also shows voltage waveforms of the pixel voltage V20 of the internal node N1 and a voltage Vn2 of the output node N2, and on/off states of the transistors T1 to T4 in each phase in the case A and case B.

In the first phase (1), an initial state setting action is performed before the start of the self polarity inverting action. First, −5 V is applied to the gate line GL, to completely turn off the transistor T4 and put the first switch circuit 22 into the unconnected state, 0 V (second voltage state) is applied to the source line SL, 0 V is applied to the selection line SEL to turn off the transistor T3 to put the second switch circuit 23 into the unconnected state, and 8 V is applied to the reference line REF to completely turn on the transistor T2 regardless of the voltage state of the internal node N1, to set the output node N2 in the same voltage state as that of the internal node N1 in each of the case A and case B. The opposite voltage Vcom is 0 V. In addition, the auxiliary capacitance line CSL is fixed to a predetermined fixed voltage (such as 0 V or 5 V). In addition, an initial voltage applied to the source line SL may be 5 V (first voltage state). In this case, since the voltage of the control terminal of the transistor T1 is the same as the voltage of the internal node N1, the diode-connected transistor T1 is put into an inversely-biased state (off state) and the second switch circuit 23 is put into the unconnected state with no need to apply 0 V to the selection line SEL to turn off the transistor T3. As a result, the first switch circuit 22 and the second switch circuit 23 are put into the unconnected state, sampling can be performed such that the voltage state of the internal node N1 is transferred to the output node N2 in each pixel circuit 2 without receiving an effect of the voltage states of the source line SL and the voltage supply line VSL.

By the way, the reason why the negative voltage −5 V is used as a voltage value to be applied to the gate line GL to completely turn off the transistor T4 is that the pixel voltage V20 could be transferred to the negative voltage in tandem with the voltage change of the opposite voltage Vcom with the voltage of the liquid crystal voltage Vlc maintained in the first switch circuit 22 in the unconnected state, and in this state, the first switch circuit 22 in the unconnected state is prevented from being put into the connected state unnecessarily. In addition, since the voltage of the source line SL is in the first voltage state (5 V) or the second voltage state (0 V) in the constant display mode, the transistor T1 in the second switch circuit 23 functions as the inversely-biased diode even when the voltage of the internal node N1 becomes the negative voltage, so that it is not always necessary to turn off the transistor T3 by keeping the voltage of the selection line SEL in the negative voltage similar to the gate line GL.

When the second phase (2) starts (t2), 0 V is applied to the reference line REF to turn off the transistor T2 regardless of the voltage state of the internal node N1, and the output node N2 is electrically isolated from the internal node N1. Thus, the initial voltage state of the internal node N1 is maintained in the output node N2, so that the output node N2 is not affected by the voltage state of the internal node N1 after that.

When the third phase (3) starts (t3), the opposite voltage Vcom is transferred from 0 V to 5 V. At this point, since only the opposite voltage Vcom changes, an absolute value of the liquid crystal voltage Vlc is changed from 0 V to 5 V and from 5 V to 0 V, and a display state of each pixel circuit is changed, but by shortening a period until the polarity is finally inversed, a temporary change of the display state can be limited to a short time, so that fluctuation in average value of the liquid crystal voltage Vlc can be extremely small to the extent that it is not perceptible by human sight. For example, when each phase period is set to 30μ second, the temporary change in the display state can be ignored in view of the human sight.

When the fourth phase (4) starts (t4), 8 V is applied to the gate line GL, to completely turn on the transistor T4 and put the first switch circuit 22 into the connected state, and 5 V (first voltage state) is applied to the source line SL to forcibly set the voltage state of the internal node N1 to 5 V (first voltage state) in each of the case A and the case B. At this point, in the case A, the liquid crystal voltage Vlc is returned to the initial voltage 0 V, and the polarity inversion is completed although the substantial polarity inversion is not generated because the absolute value is 0 V.

When the fifth phase (5) starts (t5), −5 V is applied to the gate line GL to completely turn off the transistor T4, put the first switch circuit 22 into the unconnected state, and electrically isolate the internal node N1 from the source line SL, and 0 V (second voltage state) is applied to the source line SL.

When the sixth phase (6) starts (t6), 5 V is applied to the selection line SEL to turn on the transistor T3 and put the second switch circuit 23 into the connected or the unconnected state depending on on/off state of the transistor T1. That is, in the case A, since the voltage Vn2 of the output node N2 is maintained at 5 V in the first phase, the transistor T1 is in on state, so that the second switch circuit 23 is put into the connected state and the pixel voltage V20 of the internal node N1 is changed from 5 V to 0 V. Meanwhile, in the case B, since the voltage Vn2 of the output node N2 is maintained at 0 V in the first phase, the transistor T1 is in off state, so that the second switch circuit 23 is put into the unconnected state, and the pixel voltage V20 of the internal node N1 is maintained at 5 V. At this point, in the case B, the liquid crystal voltage Vlc is changed from the initial +5 V to −5 V, and the substantial polarity inversion is completed. In addition, the on/off state of the transistor T1 from the first phase (1) to the fifth phase (5) in the case A could be in a cut-off state because the transistor T3 is in off state, more specifically, it depends on an arranged position of the transistor T1 and its voltage at both ends in the second switch circuit 23. The fact that the voltage Vn2 of the output node N2 is maintained at 5 V is more important than the off/off state of the transistor T1 until the fifth phase (5), and in FIG. 15, the on/off state of the transistor T1 is determined by the voltage state of the control terminal, for convenience.

The seventh phase (7) starts (t7), 0 V is applied to the selection line SEL to turn off the transistor T3 and put the second switch circuit 23 into the unconnected state regardless of the on/off state of the transistor T1. Thus, the internal node N1 is electrically isolated from the source line SL.

When the eighth phase (8) starts (t8), 8 V is applied to the reference line REF to completely turn on the transistor T2 regardless of the voltage state of the internal node N1 and set the output node N2 to the same voltage state as that of the internal node N1 in each of the case A and the case B. Thus, the signal lines are all returned to the initial states (first phase (1)), and the initial state setting action is executed in the first phase for the next self polarity inverting action. Therefore, the next self polarity inverting action may be started from the second phase (2). Alternatively, the next self polarity inverting action may stand by in the end state of the seventh phase (7) and may be started from the first phase (1). In addition, the initial state setting action in the first phase (1) may be executed after the programming action in the constant display mode which will be described below, and in this case also, the self polarity inverting action after the programming action may be started from the second phase (2).

As described above, through the series of actions from the first phase (1) to the seventh phase (7), the polarity of the liquid crystal voltage Vlc of all of the pixel circuits 2 as the target of the self polarity inverting action can be collectively inverted at the same time with its absolute value maintained.

In addition, the description has been made of the case where the opposite voltage Vcom is transferred from low level (0 V) to high level (5 V) in FIG. 15, but the transfer timing is the same in the case where the level is transferred from high level (5 V) to low level (0V), and when the third phase (3) starts (t3), that transfer is executed. In this case, when the voltage state of the internal node N1 is forcibly set to 5 V (first voltage state) in the fourth phase (4) in each of the case A and the case B, the liquid crystal voltage Vlc is changed from the initial −5 V to +5 V in the case B, and the substantial polarity inversion is completed. In addition, when the second switch circuit 23 is put into the connected state and the pixel voltage V20 of the internal node N1 is changed from 5 V to 0 V, in the sixth phase (6) in the case A, the liquid crystal voltage Vlc is returned to the initial 0 V, and the polarity inversion is completed although the substantial polarity inversion is not generated because the absolute value is 0 V.

Thus, the basic action in the self polarity inverting action in each phase is summarized as follows.

First phase (1): The voltage state of the internal node N1 is sampled to the output node N2.

Second phase (2): The voltage state of the internal node N1 is held in the output node N2.

Third phase (3): The opposite voltage Vcom is inverted.

Fourth phase (4): The first switch circuit 22 is put into the connected state, and the voltage state of the internal node N1 is reset to 5 V (first voltage state).

Fifth phase (5): The first switch circuit 22 is put into the unconnected state.

Sixth phase (6): The second switch circuit 23 is put into the connected state, and the voltage state of the internal node N1 is set to 0 V (second voltage state) only in the case A.

Seventh phase (7): The second switch circuit 23 is put into the unconnected state.

Eighth phase (8): The first phase (1) of the next self polarity inverting action.

According to the basic action of the above self polarity inverting action in each phase, the voltage application timing of each signal line can be appropriately changed to the extent that each basic action can be surely executed. For example, the voltage of the source line SL has to be 5 V (first voltage state) during the fourth phase (4) and 0 V (second voltage state) during the sixth phase (6) but it may be 5 V (first voltage state) or 0 V (second voltage state) in the other phases. This means that in the all of the types, the voltage of the source line SL has to be 5 V (first voltage state) during the fourth phase (4), and the voltage of the voltage supply line VSL has to be 0 V (second voltage state) during the sixth phase (6).

Furthermore, the opposite voltage Vcom in the third phase (3) may be inverted before the reset of the voltage is completed in the fourth phase (4). That is, the opposite voltage Vcom may be inverted in the fourth phase (4) without providing the third phase (3).

The voltage maintained in the output node N2 in the first phase (1) and the second phase (2) may not always correctly reflect the voltage state of the internal node N1. It is good enough to put the second switch circuit 23 into the connected state and set the voltage state of the internal node N1 to 0 V (second voltage state) by the voltage corresponding to the first voltage state of the internal node N1 in the sixth phase (6) in only the case A. In this respect, the voltage value applied to the reference line REF can be changed.

Furthermore, in the case where the voltage state of the internal node N1 is set to 5 V (first voltage state) in the fourth phase (4), the voltage level of the selection SEL may be also 5 V because the source line SL also serves as the voltage supply line VSL in the first type, and the connection state of the second switch circuit 23 does not matter when the first switch circuit 22 is in the connected state. Therefore, 5 V may be continuously applied to the selection line SEL from the fourth phase through the sixth phase.

Furthermore, in the case where the first voltage state (5V) after the reset of the internal node N1 fluctuates due to capacitance coupling between the gate of the transistor T4 and the internal node N1 when the transistor T4 is completely turned off by applying −5 V to the gate line GL at the time of the start (t5) in the fifth phase (5), the voltage of the auxiliary capacitance line CSL is adjusted and the voltage fluctuation of the internal node N1 may be compensated with capacitance coupling through the second capacitance element C2. However, since the auxiliary capacitance line CSL also serves as the voltage supply line VSL in the third type which will be described below, the voltage of the auxiliary capacitance line CSL is to be previously displaced in a reverse direction by the adjusted voltage in the fourth phase (4), and set to 0 V (second voltage state) at the start (t5) of the fifth phase (5).

In addition, the basic action of the above self polarity inverting action in each phase is common to the all types from the first type to the sixth type, so that in each of the second to sixth types, the voltage is applied to each signal line so that the action in each phase is executed similar to the first type.

### <2> Second Type Self Polarity Inverting Action

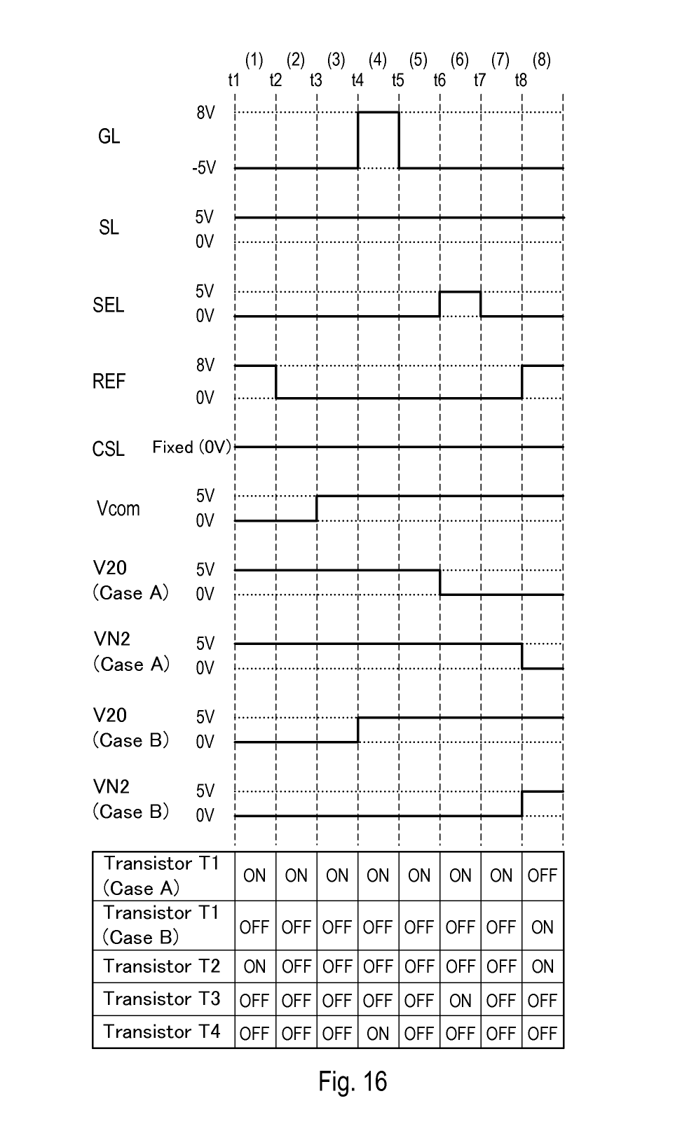

FIG. 16 shows a timing chart of a second type self polarity inverting action. As shown in FIG. 16, similar to the first type, the self polarity inverting action is divided into 8 phases (first to eighth phases). Start times of the phases are set at t1, t2, . . . , t8. FIG. 16 shows voltage waveforms of the gate line GL, the source line SL, the selection line SEL, the reference line REF, and the auxiliary capacitance line CSL connected to the pixel circuit 2B serving as the target of the self polarity inverting action, and a voltage waveform of the opposite voltage Vcom. In addition, in this embodiment, the pixel circuits in the pixel circuit array are all the target of the self polarity inverting action. In addition, FIG. 16 also shows voltage waveforms of the pixel voltage V20 of the internal node N1 and the voltage Vn2 of the output node N2, and on/off states of the transistors T1 to T4 in the phases in the case A and case B.

The second type only differs from the first type in that the reference line REF also serves as the voltage supply line VSL, and the same voltage is applied to the each signal line at the same timing as that of the first type. However, since the source line SL does not serve as the voltage supply line VSL, it is not necessarily set to 0 V (second voltage state) during the sixth phase (6), so that it may be fixed to 5 V (first voltage state) from the first phase through the eighth phase as shown in FIG. 16. During the sixth phase (6), the voltage of the reference line REF serving as the voltage supply line VSL is 0 V (second voltage state), so that it satisfies a voltage condition required for the voltage supply line VSL in the sixth phase (6). Thus, since the voltage is not changed at all in each source line SL, there is no power consumption due to charge and discharge of the source line SL, so that power saving can be achieved. For the rest, the second type is totally the same as the first type, so that a duplicative description is omitted. However, since the voltage of the reference line REF serving as the voltage supply line VSL is 0 V (second voltage state) during the fourth phase (4), the voltage level of the selection line SEL needs to be at 0 V during the fourth phase (4) because when the voltage level of the selection line SEL is set to 5 V similar to the first type, a current path from the source line SL to the reference line REF is inconveniently generated in the case A.

### <3> Third Type Self Polarity Inverting Action

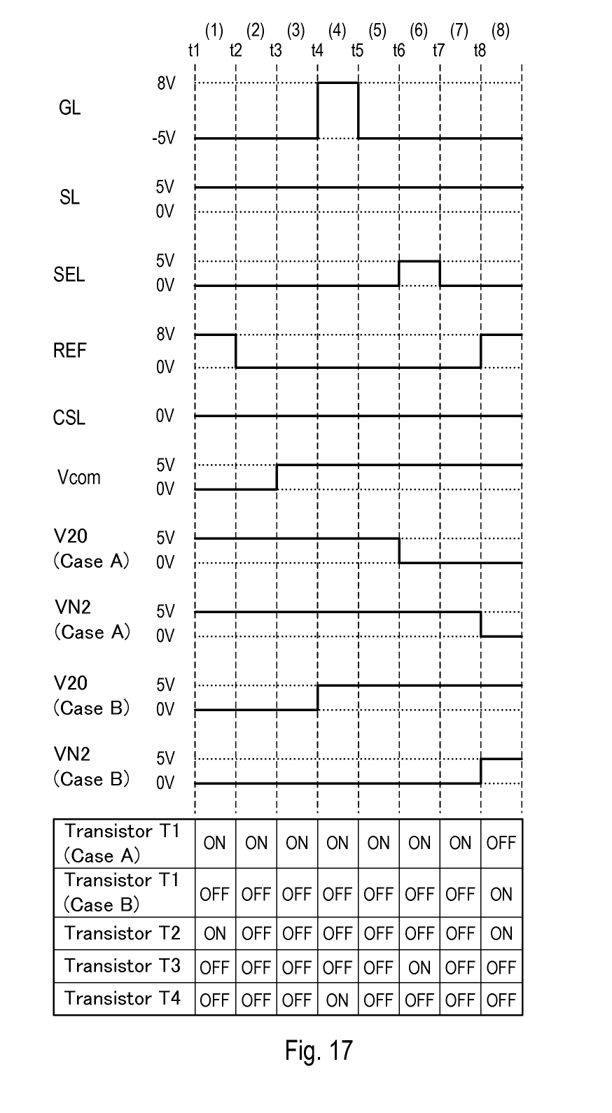

FIG. 17 shows a timing chart of a third type self polarity inverting action. As shown in FIG. 17, similar to the first type, the self polarity inverting action is divided into 8 phases (first to eighth phases). Start times of the phases are set at t1, t2, . . . , t8. FIG. 17 shows voltage waveforms of the gate line GL, the source line SL, the selection line SEL, the reference line REF, and the auxiliary capacitance line CSL connected to the pixel circuit 2C serving as the target of the self polarity inverting action, and a voltage waveform of the opposite voltage Vcom. In addition, in this embodiment, the pixel circuits in the pixel circuit array are all the target of the self polarity inverting action. In addition, FIG. 17 also shows voltage waveforms of the pixel voltage V20 of the internal node N1 and the voltage Vn2 of the output node N2, and on/off states of the transistors T1 to T4 in the phases in the case A and case B.

The third type only differs from the first type in that the auxiliary capacitance line CSL also serves as the voltage supply line VSL, and the same voltage is applied to the signal line at the same timing as that of the first type. However, since the source line SL does not serve as the voltage supply line VSL, it is not necessarily set to 0 V (second voltage state) during the sixth phase (6), so that it may be fixed to 5 V (first voltage state) from the first phase through the eighth phase as shown in FIG. 17. Thus, since the voltage is not changed at all in the source line SL, there is no power consumption due to charge and discharge of the source line SL, so that power saving can be achieved.

In addition, in the first and second types, the auxiliary capacitance line CSL may be a fixed voltage (such as 5 V) other than 0 V, but in the third type, since it also serves as the voltage supply line VSL, it needs to be fixed to 0 V (second voltage state). For the rest, the third type is totally the same as the first type, so that a duplicative description is omitted. However, since the voltage of the auxiliary capacitance line CSL serving as the voltage supply line VSL is 0 V (second voltage state) during the fourth phase (4), the voltage level of the selection line SEL needs to be 0 V during the fourth phase (4) similar to the first type because when the voltage level of the selection line SEL is set to 5 V, a current path from the source line SL to the reference line REF is inconveniently generated in the case A.

### <4> Fourth Type Self Polarity Inverting Action

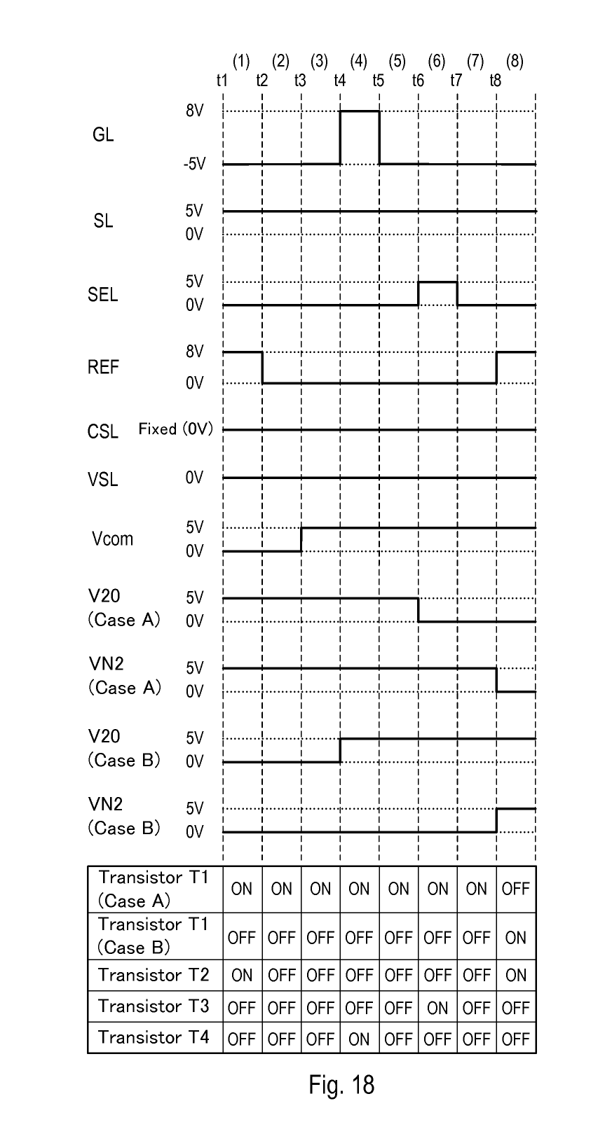

FIG. 18 shows a timing chart of a fourth type self polarity inverting action. As shown in FIG. 18, similar to the first type, the self polarity inverting action is divided into 8 phases (first to eighth phases). Start times of the phases are set at t1, t2, . . . , t8. FIG. 18 shows voltage waveforms of the gate line GL, the source line SL, the selection line SEL, the reference line REF, the voltage supply line VSL, and the auxiliary capacitance line CSL connected to the pixel circuit 2D serving as the target of the self polarity inverting action, and a voltage waveform of the opposite voltage Vcom. In addition, in this embodiment, the pixel circuits in the pixel circuit array are all the target of the self polarity inverting action. In addition, FIG. 18 also shows voltage waveforms of the pixel voltage V20 of the internal node N1 and the voltage Vn2 of the output node N2, and on/off states of the transistors T1 to T4 in the phases in the case A and case B.

The fourth type only differs from the first type in that the voltage supply line VSL is the independent signal line, so that when a voltage application condition of the voltage supply line VSL is set to the same as that of the source line SL, the same voltage is applied to the each signal line at the same timing as that of the first type. However, since the source line SL does not serve as the voltage supply line VSL, it is not necessary to apply 0 V (second voltage state) during the sixth phase (6), so that the source line SL may be fixed to 5 V (first voltage state) from the first phase through the eighth phase as shown in FIG. 18. Thus, since the voltage is not changed at all the source line SL, there is no power consumption due to charge and discharge of the source line SL, so that power saving can be achieved.

As for the voltage supply line VSL, it is required to apply 0 V (second voltage state) thereto during the sixth phase (6), and it is required to set the voltage state of the internal node N1 to 0 V (second voltage state) through the second switch circuit 23 in the connected state in the case A, and the voltage state in the other phase is not necessarily at 0 V (second voltage state), but it is preferably fixed to 0 V (second voltage state) from the first phase through the eighth phase to avoid unnecessary charge and discharge of the voltage supply line VSL. In addition, by applying 5 V (first voltage state) to the voltage supply line VSL in the phases other than sixth phase (6), the diode-connected transistor T1 is put into a reversely-biased state (off state) and the second switch circuit 23 is put into the unconnected state because the voltage of the control terminal of the transistor T1 is the same voltage as that of the internal node N1 with no need to apply 0 V to the selection line SEL to turn off the transistor T3 at the sampling action in the first phase (1). For the rest, the fourth type is totally the same as the first type, so that a duplicative description is omitted. However, when the voltage supply line VSL is fixed to 0 V (second voltage state) during the fourth phase (4), the voltage level of the selection line SEL needs to be 0 V during the fourth phase (4) because when the voltage level of the selection line SEL is set to 5 V, a current path from the source line SL to the reference line REF is inconveniently generated in the case A.

### <5> Fifth Type Self Polarity Inverting Action

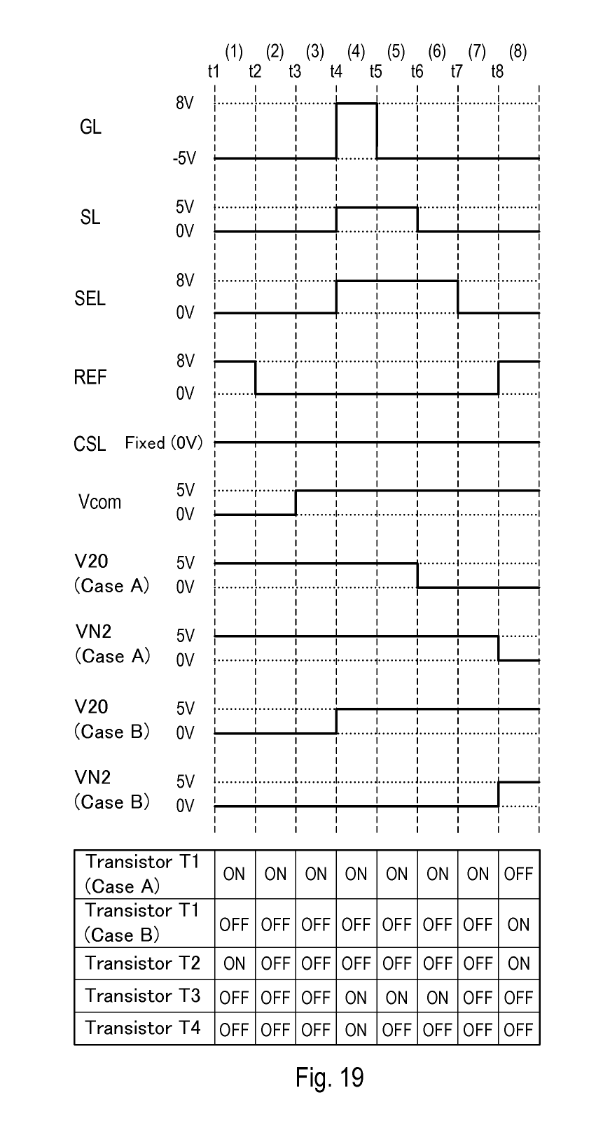

FIG. 19 shows a timing chart of a fifth type self polarity inverting action. As shown in FIG. 19, similar to the first type, the self polarity inverting action is divided into 8 phases (first to eighth phases). Start times of the phases are set at t1, t2, . . . , t8. FIG. 19 shows voltage waveforms of the gate line GL, the source line SL, the selection line SEL, the reference line REF, and the auxiliary capacitance line CSL connected to the pixel circuit 2E serving as the target of the self polarity inverting action, and a voltage waveform of the opposite voltage Vcom. In addition, in this embodiment, the pixel circuits in the pixel circuit array are all the target of the self polarity inverting action. In addition, FIG. 19 also shows voltage waveforms of the pixel voltage V20 of the internal node N1 and voltage Vn2 of the output node N2, and on/off states of the transistors T1 to T4 in the phases in the case A and case B.

The fifth type and the first type are the same in that the source line SL also serves as the voltage supply line VSL, but the fifth type differs from the first type in that the transistor T3 is included in the series circuit of the first switch circuit 22. Therefore, in order to put the first switch circuit 22 into the connected state in the fourth phase (4), it is necessary to turn on each of the transistor T3 and the transistor T4, and as shown in FIG. 19, it is necessary to set the voltage level of the selection line SEL to 8 V which is the same as that of the gate line GL during the fourth phase (4) and the sixth phase (6). The same voltage is applied to the each signal line other than the selection lines SEL at the same timing as the first type. In addition, in the fifth type, a resetting action in the sixth phase (6) is different from that of the first type, and it starts when the voltage of the source line SL is transferred to 0 V. Therefore, when the voltage of the source line SL is transferred at the time of the start of the fifth phase (5), the resetting action starts in the fifth phase (5), so that the sixth phase (6) is not needed. For the rest, the fifth type is totally the same as the first type, so that a duplicative description is omitted. In addition, when the first switch circuit is put into the unconnected state, the voltage of the selection line SEL to turn off the transistor T3 may be 0 V instead of −5 V because the transistor T4 is completely in off state as shown in FIG. 19.

### <6> Sixth Type Self Polarity Inverting Action

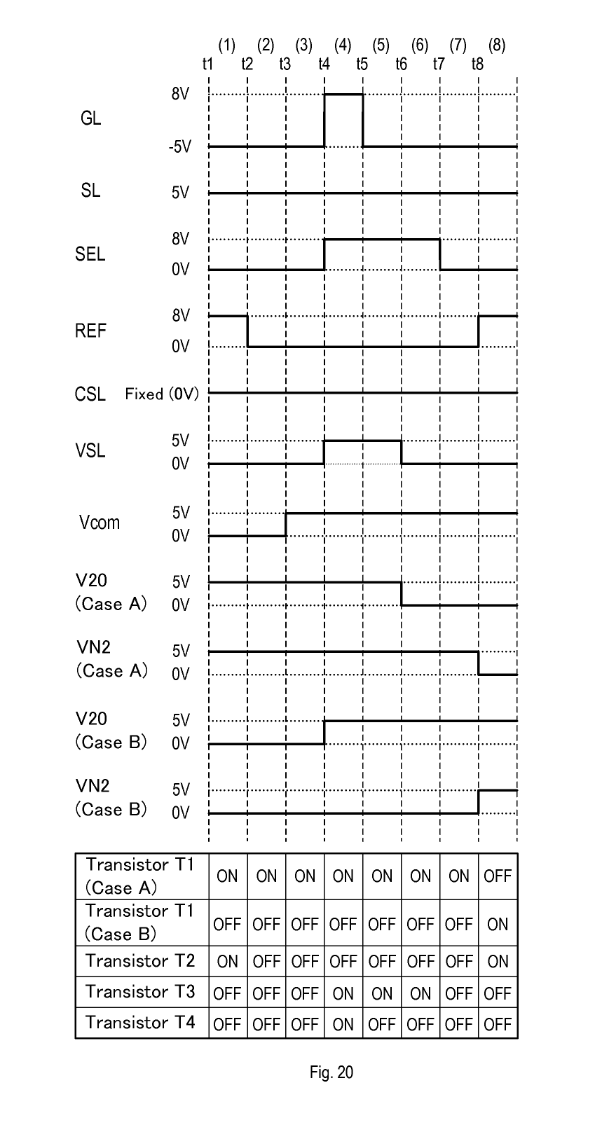

FIG. 20 shows a timing chart of a sixth type self polarity inverting action. As shown in FIG. 20, similar to the first type, the self polarity inverting action is divided into 8 phases (first to eighth phases). Start times of the phases are set at t1, t2, . . . , t8. FIG. 20 shows voltage waveforms of the gate line GL, the source line SL, the selection line SEL, the reference line REF, the voltage supply line VSL, and the auxiliary capacitance line CSL connected to the pixel circuit 2F serving as the target of the self polarity inverting action, and a voltage waveform of the opposite voltage Vcom. In addition, in this embodiment, the pixel circuits in the pixel circuit array are all the target of the self polarity inverting action. In addition, FIG. 20 also shows voltage waveforms of the pixel voltage V20 of the internal node N1 and the voltage Vn2 of the output node N2, and on/off states of the transistors T1 to T4 in the phases in the case A and case B.

The sixth type only differs from the fifth type in that the voltage supply line VSL is the independent signal line, and when the voltage supply line VSL is set to the same condition as the source line, the same voltage is applied to the each signal line at the same timing as that of the fifth type. However, since the source line SL does not serve as the voltage supply line VSL, it is not necessary to apply 0 V (second voltage state) during the sixth phase (6), so that it may be fixed to 5 V (first voltage state) from the first phase through the eighth phase as shown in FIG. 20. Thus, since the voltage is not changed at all in the source line SL, there is no power consumption due to charge and discharge of the source line SL, so that power saving can be achieved. However, the voltage of the voltage supply line VSL is required to be 5 V (first voltage state) during the fourth phase (4) and to be 0 V (second voltage state) during the sixth phase (6) similar to the source line SL in the first type and fifth type. In addition, in the sixth type, a resetting action in the sixth phase (6) starts when the voltage of the voltage supply line VSL is transferred to 0 V. Therefore, when the voltage of the voltage supply line VSL is transferred at the time of the start of the fifth phase (5), the resetting action starts in the fifth phase (5), so that the sixth phase (6) is not needed. For the rest, the sixth type is totally the same as the fifth type, so that a duplicative description is omitted.

### Third Embodiment

According to a third embodiment, a description will be made of programming actions in the constant display mode in the pixel circuits 2A to 2F having the first to sixth type circuit configurations shown in FIGS. 5 to 8, 11, and 12, with reference to the drawings with respect to each type.

According to the programming action in the constant display mode, the pixel data for one frame is divided with respect to each display line in the horizontal direction (row direction), a binary voltage (high level (5 V) or low level (0 V)) corresponding to each pixel data for the one display line is applied to the source line SL in each column every one horizontal period, a selected row voltage 8 V is applied to the gate line GL of the selected display line (selected row), all of the first switch circuits 22 of the pixel circuits 2 belonging to the selected row are put into the connected state, and the voltage of the source line SL in each column is transferred to each of the internal nodes N1 of the pixel circuits 2 in the selected row. An unselected row voltage −5 V is applied to the gate line GL (unselected row) other than the selected display line to put the first switch circuits 22 of the pixel circuits 2 in the unselected row into the unconnected state. In addition, the timing for applying the voltage to the each signal line in the programming action to be described below is controlled by the display control circuit 11 shown in FIG. 1, and the respective voltages are applied by the display control circuit 11, the opposite electrode drive circuit 12, the source driver 13, and the gate driver 14.

### <1> First to Fourth Type Programming Actions

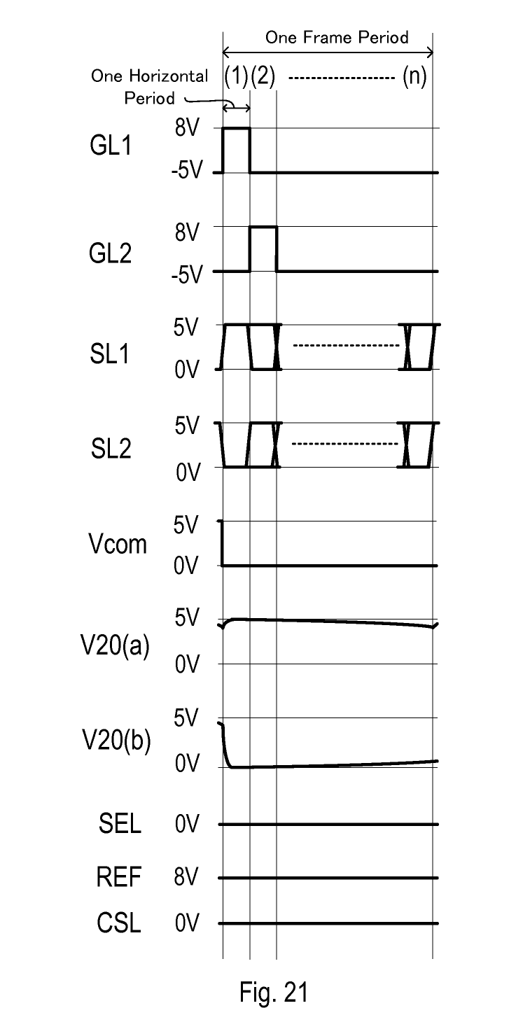

FIG. 21 shows a timing chart of a programming action in the first type pixel circuit 2A among the first to fourth types. FIG. 21 shows waveforms of two gate lines GL1 and GL2, two source lines SL1 and SL2, the selection line SEL, the reference line REF, and the auxiliary capacitance line CSL, and a voltage waveform of the opposite voltage Vcom during the one frame period. In addition, FIG. 21 also shows voltage waveforms of the pixel voltages V20 of the internal nodes N1 of the two pixel circuits 2A. One of the two pixel circuits 2A is a pixel circuit 2A(a) selected by the gate line GL1 and the source line SL1, and the other is a pixel circuit 2A(b) selected by the gate line GL1, and the source line SL2, which are discriminated by adding (a) and (b) after the pixel voltages V20 in the drawing.

The one frame period is divided into the horizontal periods corresponding to the number of the gate lines GL, and the gate lines GL1 to GLn selected during the horizontal periods are sequentially allocated thereto. FIG. 21 shows voltage changes of the two gate lines GL1 and GL2 in the first two horizontal periods. In the first horizontal period, the selected row voltage 8 V is applied to the gate line GL1, and the unselected row voltage −5 V is applied to the gate line GL2, and in the second horizontal period, the selected row voltage 8 V is applied to the gate line GL2, and the unselected row voltage −5 V is applied to the gate line GL1, and in the horizontal periods after that, the unselected row voltage −5 V is applied to each of the gate line GL1 and GL2. A voltage (5V or 0V) corresponding to the pixel data of the display line corresponding to each horizontal period is applied to the source line SL in each column (two source lines SL1 and SL2 are shown in FIG. 21). In addition, in the example shown in FIG. 21, the voltages of the two source lines SL1 and SL2 in the first one horizontal period are separately set to 5 V and 0 V in order to explain the change of the pixel voltage V20.

According to the first to fourth type pixel circuits 2A to 2D, since the first switch circuit 22 consists of the transistor T4, the first switch circuit 22 is connected or disconnected only by turning on/off the transistor T4. In addition, it is not necessary to put the second switch circuit 23 into the connected state in the programming action, so that a non-selecting voltage 0V (or −5 V) is applied to the selection line SEL connected to all of the pixel circuits 2A for one frame period, in order to prevent the second switch circuits 23 from being put into the connected state in the pixel circuits 2A in the unselected row. A voltage 8 V which is higher than the high level voltage (5V) by a threshold voltage (about 2 V) or more is applied to the reference line REF in order to keep the transistor T2 in the on state for the one frame period regardless of the voltage state of the internal node N1. Thus, the output node N2 and the internal node N1 are electrically connected, and the first capacitance element C1 connected to the internal node N1 can be used to hold the pixel voltage V20, which can contribute to stabilizing the pixel voltage V20. In addition, the auxiliary capacitance line CSL is fixed to a predetermined fixed voltage (such as 0 V). As for the opposite voltage Vcom, the above-described opposite AC driving is performed, and it is fixed to 0 V or 5 V for the one frame period. In FIG. 21, the opposite voltage Vcom is fixed to 0 V.

The second type pixel circuit 2B only differs from the first type in that the reference line REF also serves as the voltage supply line VSL, and the same voltage is applied to the each signal line at the same timing as the first type. Similarly, the third type pixel circuit 2C only differs from the first type in that the auxiliary capacitance line CSL also serves as the voltage supply line VSL, and the same voltage is applied to the each signal line at the same timing as the first type.

The fourth type pixel circuit 2D only differs from the first to third types in that the voltage supply line VSL is the independent signal line, and the same voltage is applied to the each signal line at the same timing as the first to third types. As long as the non-selecting voltage is applied to the selection line SEL to turn off the transistor T3 and put the second switch circuit 23 into the unconnected state, it is not necessary to apply the same voltage as the source line SL to the voltage supply line VSL, and it may be fixed to a predetermined constant voltage (such as 0 V) although not shown. In addition, by applying 5 V (first voltage state) to the voltage supply line VSL in the second to fourth types, the diode-connected transistor T1 is put into the reversely-biased state (off state) and the second switch circuit 23 is put into the unconnected state because the voltage of the control terminal of the transistor T1 is the same as the internal node N1 with no need to apply 0 V to the selection line SEL to turn off the transistor T3.

### <2> Fifth Type Programming Action

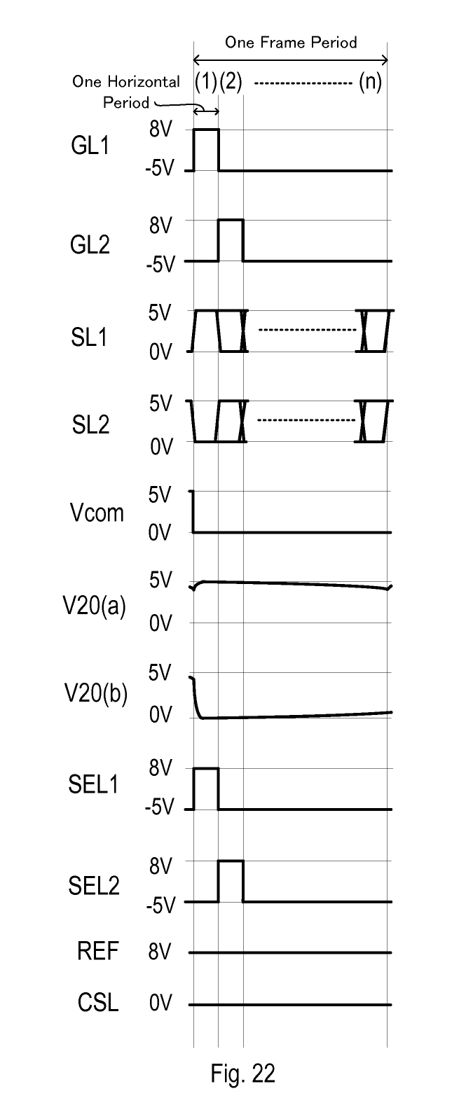

FIG. 22 shows a timing chart of a programming action in the fifth type pixel circuit 2E. FIG. 22 shows waveforms of the two gate lines GL1 and GL2, the two source lines SL1 and SL2, the two selection lines SEL1 and SEL2, the reference line REF, and the auxiliary capacitance line CSL, and a voltage waveform of the opposite voltage Vcom in the one frame period. In addition, FIG. 22 also shows voltage waveforms of the pixel voltages V20 of the internal nodes N1 of the two pixel circuits 2A. One of the two pixel circuits 2A is the pixel circuit 2A(a) selected by the gate line GL1 and the source line SL1, and the other is the pixel circuit 2A(b) selected by the gate line GL1 and the source line SL2, which are discriminated by adding (a) and (b) after the pixel voltages V20 in the drawing.

Voltage application timing and voltage amplitude for each of the gate line GL (GL1 and GL2) and the source line SL (SL1 and SL2) are completely the same as those in the first to fourth types shown in FIG. 21.

According to the fifth type pixel circuit 2E, since the first switch circuit 22 includes the series circuit composed of the transistor T3 and the transistor T4, the on/off control of the transistor T3 is needed in addition to the on/off control of the transistor T4 to control the connection/disconnection of the first switch circuit 22. Therefore, according to the fifth type, unlike the first to fourth types, all of the selection lines SEL are not collectively controlled but they are individually controlled by the row like the gate line GL. That is, the selection line SEL is provided in each row and its number is the same as that of the gate lines GL1 to GLn, and they are sequentially selected similar to the gate lines GL1 to GLn. FIG. 22 shows the voltage changes of the two selection lines SEL1 and SEL2 in first two horizontal periods. In the first horizontal period, the selecting voltage 8 V is applied to the selection line SEL1, and the non-selecting voltage −5 V is applied to the selection line SEL2, and in the second horizontal period, the selecting voltage 8 V is applied to the selection line SEL2, and the non-selecting voltage −5 V is applied to the selection line SEL1, and in the horizontal periods after that, the non-selecting voltage −5 V is applied to each of the selection lines SEL1 and SEL2. Voltages applied to the reference line REF and the auxiliary capacitance line CSL, and the opposite voltage Vcom are the same as those of the first type shown in FIG. 21. In addition, when the first switch circuits 22 are put into the unconnected state in the unselected row, the non-selecting voltage of the selection line SEL to turn off the transistor T3 may be 0 V instead of −5 V because the transistor T4 is completely in off state.

According to the fifth type programming action, since the transistor T1 of the second switch circuit 23 is in on state in some cases, depending on the voltage state of the internal node N1 before the programming action, the transistors T3 are also in on state in the selected row, so that both of the first switch circuit 22 and the second switch circuit 23 are in the connected state at the same time. However, in the case of the fifth type, since the source line SL also serves as the voltage supply line VSL, one end of the second switch circuit 23 is connected to the source line SL similar to the first switch circuit 22, so that there is no problem because as long as the selection line SEL is controlled by the row, the second switch circuits 23 are put into the unconnected state in the pixel circuits 2E in the unselected row.

### <3> Sixth Type Programming Action

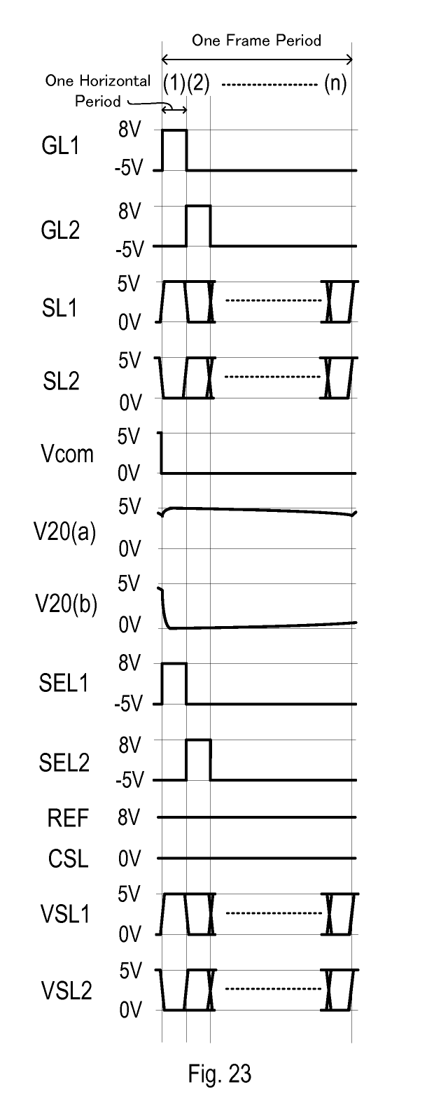

FIG. 23 shows a timing chart of a programming action in the sixth type pixel circuit 2F. FIG. 23 shows waveforms of the two gate lines GL1 and GL2, the two source lines SL1 and SL2, the two selection lines SEL1 and SEL2, the two voltage supply lines VSL1 and VSL2, the reference line REF, and the auxiliary capacitance line CSL, and a voltage waveform of the opposite voltage Vcom in the one frame period. In addition, FIG. 23 also shows voltage waveforms of the pixel voltages V20 of the internal nodes N1 of the two pixel circuits 2A. One of the two pixel circuits 2A is a pixel circuit 2A(a) selected by the gate line GL1 and the source line SL1, and the other is a pixel circuit 2A(b) selected by the gate line GL1, and the source line SL2, which are discriminated by adding (a) and (b) after the pixel voltages V20 in the drawing.

Voltage application timing and voltage amplitude for each of the gate line GL (GL1 and GL2) and the source line SL (SL1 and SL2) are completely the same as those in the first to fourth types shown in FIG. 21, and the fifth type shown in FIG. 22.

According to the sixth type pixel circuit 2F, since the first switch circuit 22 includes the series circuit composed of the transistor T3 and the transistor T4, the on/off control of the transistor T3 is needed in addition to the on/off control of the transistor T4 to control the connection/disconnection of the first switch circuit 22, which is the same as that of the fifth type. The sixth type pixel circuit 2F differs from the fifth type in that the voltage supply line VSL is the independent signal line, so that the voltage of the voltage supply line VSL needs to be controlled separately. As described above, according to the sixth type, the voltage supply line VSL extends in the vertical direction (column direction) so as to be parallel to the source line SL, and can be individually driven by the column.

When the voltage supply line VSL extends in the vertical direction (column direction) so as to be parallel to the source line SL and can be individually driven by the column in the sixth type, the first switch circuit 22 and the second switch circuit 23 could be both put into the connected state in the selected row at the same time, similar to the fifth type, so that there is a drive method to set the voltage of the voltage supply line VSL connected to one end of the second switch circuit 23 to the same as that of the source line SL connected to the one end of the first switch circuit 22 that is paired with the second switch circuit 23. When there is a difference between the source line SL and the voltage supply line VSL connected to the first switch circuit 22 and the second switch circuit 23 which have been put into the connected state at the same time, respectively, during the programming action, there is a possibility that a current path is generated between the source line SL and the voltage supply line VSL, and a voltage of the node positioned between them fluctuates, so that the pixel voltage V20 could not be correctly programmed in the internal node N1. Thus, the possibility can be excluded by the above drive method. In addition, since 8 V is applied to the reference line REF, and the transistor T2 is in on state, the voltage of the control terminal of the transistor T1 is the same as that of the internal node N1, so that the diode-connected transistor T1 becomes the reversely-biased state (off state) by applying 5 V (first voltage state) to the voltage supply line VSL, and the first switch circuit 22 in the selected row can be put into the unconnected state. Therefore, the problem (the above possibility) caused when the first switch circuit 22 and the second switch circuit 23 are put into the connected state at the same time in the selected row can be solved without using the above drive method. This means that the sixth type circuit may be constituted such that the voltage supply line VSL extends in the lateral direction (row direction) so as to be parallel to the gate line GL.

### Fourth Embodiment

According to a fourth embodiment, a description will be made of a relationship between the self polarity inverting action and the programming action in the constant display mode.

In the constant display mode, the programming action is not performed every frame, but the programming action is performed intermittently after the predetermined number of frame periods has elapsed. During that time, all of the pixel circuits 2A are in the unconnected state, and the unselected row voltage −5 V is applied to all of the gate lines GL, and the non-selecting voltage −5 V is applied to all of the selection lines SEL, so that each of the first switch circuit 22 and the second switch circuit 23 is put into the unconnected state, and the internal node N1 is electrically isolated from the source line SL. However, as described above, the pixel voltage V20 of the internal node N1 gently changes due to the leak current at the time of off of the transistor T4 connected to the internal node N1. Therefore, when an interval of the frame period in which the programming action is stopped is long, the display image changes due to the fluctuation of the liquid crystal voltage Vlc. Thus, it is necessary to perform the programming action again before that change exceeds an allowable maximum in view of human eyesight. In a case where the programming action is executed again on the same display image, the voltage value of the opposite voltage Vcom is inverted between high level (5 V) and low level (0V), and the voltage applied to the source line SL is also inverted between high level (5 V) and low level (0 V), so that the same pixel data can be reprogrammed. This corresponds to the “external polarity inverting action” which is the conventional polarity inverting action using the external pixel memory.

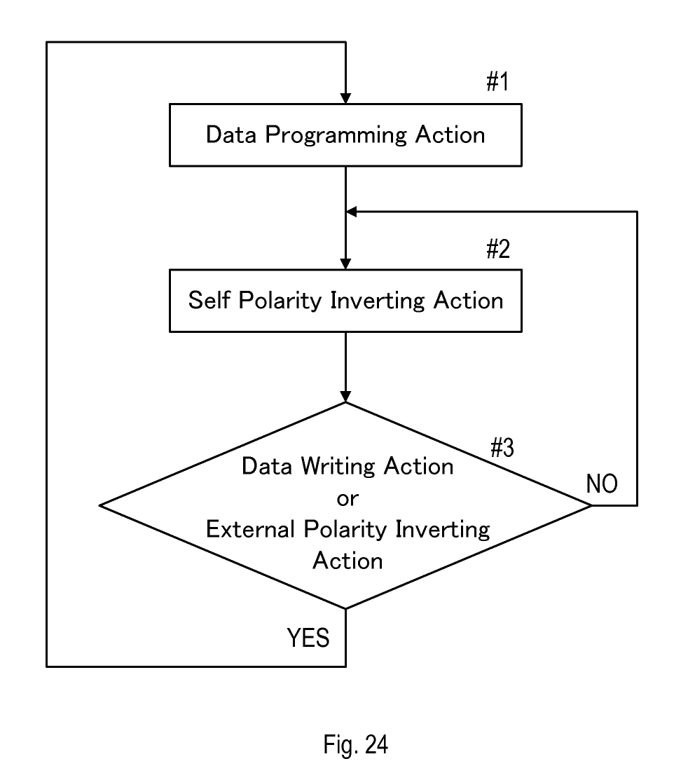

The above external polarity inverting action is completely the same as the programming action, and the pixel data for the one frame is divided into several horizontal periods whose number is the same as the number of the gate lines and programmed, so that it is necessary to change the source line SL in each column with respect to each maximum horizontal period, which requires great power consumption. Therefore, in this embodiment, the self polarity inverting action and the programming action are combined and executed in the constant display mode based on a flowchart shown in FIG. 24, so that the power consumption can be considerably reduced.

First, the programming action of the pixel data for the one frame is executed in the constant display mode as described above (step #1).

Then, after the programming action has been executed in step #1, and a stand-by period corresponding to the predetermined number of the frame periods has elapsed, the self polarity inverting action is collectively performed for the pixel circuit 2 for the one frame in the constant display mode as described above (step #2). As a result, as shown in FIGS. 21 to 23, a fine fluctuation of the pixel voltage V20 generated during the above stand-by period and a fluctuation which has been similarly generated in the liquid crystal voltage Vlc (=V20−Vcom) are initialized, so that the pixel voltage V20 returns to the pixel voltage V20 (5 V, 0V) provided just after the programming action, and the polarity of the liquid crystal voltage Vlc is inversed while keeping the same absolute value as the voltage value provided just after the programming action. Therefore, by the self polarity inverting action, a refreshing action and the polarity inverting action are executed at the same time.

After the self polarity inverting action in step #2, when the request for a new pixel data programming action (data writing), or the request for the “external polarity inverting action” is received from the outside (YES in step #3) during the above stand-by period, the operation is returned to step #1, and new pixel data or previous pixel data is programmed. Meanwhile, when that request is not received during the stand-by period (NO in step #3), the operation is returned to step #2 after the stand-by period has elapsed, and the self polarity inverting action is executed again. Thus, every time the stand-by period elapses, the self polarity inverting action is repeated, so that the refreshing action and the polarity inverting action of the liquid crystal voltage Vlc are executed to prevent the liquid crystal display element from deteriorating and the display quality from being lowered.

When the refreshing action is performed only by the “external polarity inverting action” without performing the self polarity inverting action, the power consumption is the one expressed by the relational expression shown in the formula 1, but when the self polarity inverting action is repeated at the same refreshing rate, the variable number n in the formula 1 is equal to 1 because the source line voltage is driven one time, and when the VGA is assumed as a display resolution (pixel number), m=1920 and n=480, so that the power consumption is expected to be reduced to one-480^{th} of it.

By setting the request interval of the “external polarity inverting action” in step #3 to 10 to 1000 times as long as the repeat cycle of the self polarity inverting action, the variable number f in the formula 1 is reduced to one-tenth to one-thousandth of it, so that an increase in power consumption due to the external polarity inverting action can be considerably suppressed.

In addition, the reason why the self polarity inverting action and the external polarity inverting action are combined in this embodiment is to deal with a case where even in the pixel circuit 2 which has been normally operated at first, the second switch circuit 23 or the control circuit 24 comes to be defective due to an aging change, so that there is a possibility that the programming action can be normally executed but the self polarity inverting action cannot be normally executed in some pixel circuits 2. That is, when only depending on the self polarity inverting action, deterioration occurs in the display of that pixel circuit 2 and this is fixed, but when the external polarity inverting action is combined, the display defect can be prevented from being fixed.

### Fifth Embodiment

According to a fifth embodiment, a description will be made of the programming action in the normal display mode in the pixel circuits 2A to 2F having the first to sixth type circuit configurations shown in FIGS. 5 to 8, 11, and 12 with reference to the drawings.

According to the programming action in the normal display mode, the pixel data for the one frame is divided with respect to each display line in the horizontal direction (row direction), a multiple-tone analog voltage corresponding to each pixel data for the one display line is applied to the source line SL in each column every one horizontal period, the selected row voltage 8 V is applied to the gate line GL in the selected display line (selected row), all of the first switch circuits 22 of the pixel circuits 2 in the selected row are put into the connected state, and a voltage of the source line SL in each column is transferred to the internal node N1 of each pixel circuit 2 in the selected row. The unselected row voltage −5 V is applied to the gate line GL (unselected row) other than the selected display line to put all of the first switch circuits 22 of the pixel circuits 2 in the selected row into the unconnected state. In addition, the timing for applying the voltage to the each signal line in the programming action to be described below is controlled by the display control circuit 11 shown in FIG. 1, and the respective voltages are applied by the display control circuit 11, the opposite electrode drive circuit 12, the source driver 13, and the gate driver 14.

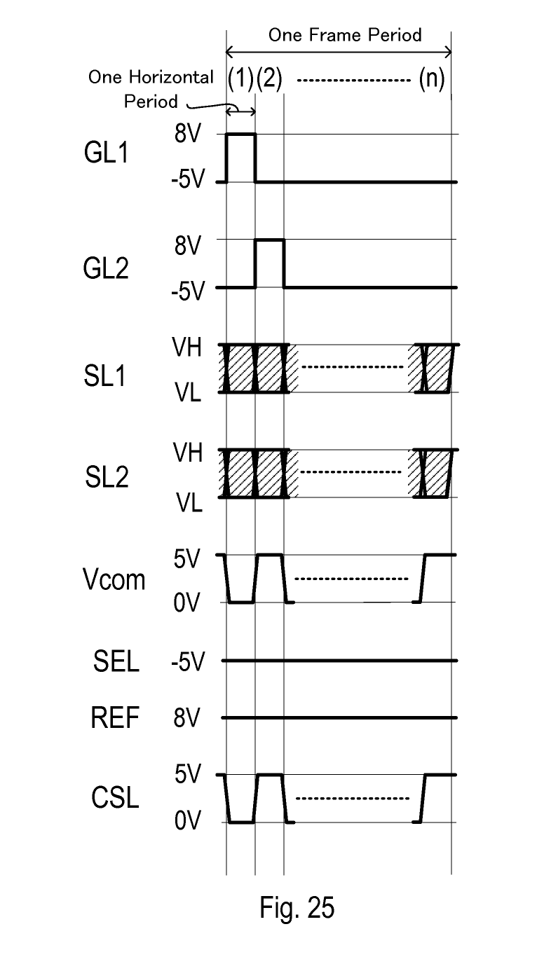

FIG. 25 shows a timing chart of the programming action in the first type pixel circuit 2A among the first to sixth types. FIG. 25 shows voltage waveforms of the two gate lines GL1 and GL2, two source lines SL1 and SL2, the selection line SEL, the reference line REF, and the auxiliary capacitance line CSL, and a voltage waveform of the opposite voltage Vcom during the one frame period.

The one frame period is divided into the horizontal periods corresponding to the number of the gate lines GL, and the gate lines GL1 to GLn selected during the horizontal periods are sequentially allocated thereto.

FIG. 25 shows voltage changes of the two gate lines GL1 and GL2 in the first two horizontal periods. In the first horizontal period, the selected row voltage 8 V is applied to the gate line GL1, and the unselected row voltage −5 V is applied to the gate line GL2, and in the second horizontal period, the selected row voltage 8 V is applied to the gate line GL2, and the unselected row voltage −5 V is applied to the gate line GL1, and in the horizontal periods after that, the unselected row voltage −5 V is applied to each of the gate line GL1 and GL2. A multiple-tone analog voltage (multiple tone is shown by cross-hatching in the drawing) corresponding to the pixel data of the display line corresponding to each horizontal period is applied to the source line SL in each column (two source lines SL1 and SL2 are shown in FIG. 25). In addition, since the opposite voltage Vcom changes every one horizontal period (opposite AC driving), the analog voltage has a voltage value corresponding to the opposite voltage Vcom in the same horizontal period. That is, the analog voltage applied to the source line SL is set such that the liquid crystal voltage Vlc provided in the formula 2 takes the same absolute value corresponding to the pixel data while only the polarity of the opposite voltage Vcom is different between 5 V and 0 V.

According to the first to fourth type pixel circuits 2A to 2D, since the first switch circuit 22 consists of the transistor T4, the first switch circuit 22 is connected or disconnected only by turning on/off the transistor T4. In addition, it is not necessary to put the second switch circuit 23 into the connected state in the programming action, so that a non-selecting voltage −5 V (or 0 V) is applied to the selection line SEL connected to all of the pixel circuits 2A for one frame period, in order to prevent the second switch circuits 23 from being put into the connected state in the pixel circuits 2A in the unselected row. A voltage 8 V which is higher than a maximum voltage VH (such as 5V) of the analog voltage by a threshold voltage (about 2 V) or more is applied to the reference line REF in order to keep the transistor T2 in the on state for the one frame period regardless of the voltage state of the internal node N1. Thus, the output node N2 and the internal node N1 are electrically connected, and the first capacitance element C1 connected to the internal node N1 can be used to hold the pixel voltage V20, which can contribute to stabilizing the pixel voltage V20.

As described above, since the opposite voltage Vcom is driven by the opposite AC driving every one horizontal period, the auxiliary capacitance line CSL is driven so as to have the same voltage as the opposite voltage Vcom. This is because since the pixel electrode 20 is capacitance-coupled with the opposite electrode 80 through the liquid crystal layer, and also capacitance-coupled with the auxiliary capacitance line CSL through the auxiliary capacitance element C2, the change of the opposite voltage Vcom is divided between the auxiliary capacitance line CSL and the auxiliary capacitance element C2 and appears in the pixel electrode 20 when the voltage of the auxiliary capacitance element C2 is fixed on the side of the auxiliary capacitance line CSL, so that the liquid crystal voltage Vlc of the pixel circuit 2 fluctuates in the unselected row. Therefore, when the auxiliary capacitance line CSL is driven at the same voltage as the opposite voltage Vcom, voltages of the opposite electrode 80 and the pixel electrode 20 change in the same voltage direction and the liquid crystal voltage Vlc of the pixel circuit 2 can be prevented from fluctuating in the unselected row.

The second type pixel circuit 2B only differs from the first type in that the reference line REF also serves as the voltage supply line VSL, and the same voltage is applied to the each signal line at the same timing as the first type. Similarly, the third type pixel circuit 2C only differs from the first type in that the auxiliary capacitance line CSL also serves as the voltage supply line VSL, and the same voltage is applied to the each signal line at the same timing as the first type.

The fourth type pixel circuit 2D only differs from the first to third types in that the voltage supply line VSL is the independent signal line, and the same voltage is applied to the signal line other than the voltage supply line VSL at the same timing as the first to third types. As long as the non-selecting voltage −5 V (or 0 V) is applied to the selection line SEL to turn off the transistor T3 and put the second switch circuit 23 into the unconnected state, it is not necessary to apply the same voltage as the source line SL to the voltage supply line VSL, and the voltage supply line VSL may be fixed to a predetermined constant voltage (such as 0 V) although not shown.

According to the fifth type pixel circuit 2E, since the first switch circuit 22 includes the series circuit composed of the transistor T3 and the transistor T4, the on/off control of the transistor T3 is needed in addition to the on/off control of the transistor T4 to control the connection/disconnection of the first switch circuit 22. Therefore, according to the fifth type, unlike the first to fourth types, all of the selection lines SEL are not collectively controlled but they are individually controlled by the row like the gate line GL. That is, the selection line SEL is provided in each row and its number is the same as that of the gate lines GL1 to GLn, and they are sequentially selected similar to the gate lines GL1 to GLn. In the first horizontal period, the selecting voltage 8 V is applied to the selection line SEL1 in the same row as the gate line GL1, and the non-selecting voltage −5 V (or 0 V) is applied to the selection line SEL2 in the same row as the gate line GL2, and in the second horizontal period, the selecting voltage 8 V is applied to the selection line SEL2, and the non-selecting voltage −5 V (or 0 V) is applied to the selection line SEL1, and in the horizontal periods after that, the non-selecting voltage −5 V (or 0 V) is applied to each of the selection lines SEL1 and SEL2. Voltages applied to the reference line REF and the auxiliary capacitance line CSL, and the opposite voltage Vcom are the same as those of the first type shown in FIG. 25.

According to the sixth type pixel circuit 2F, since the first switch circuit 22 includes the series circuit composed of the transistor T3 and the transistor T4, the on/off control of the transistor T3 is needed in addition to the on/off control of the transistor T4 to control the connection/disconnection of the first switch circuit 22, which is the same as that of the fifth type. The sixth type pixel circuit 2F differs from the fifth type in that the voltage supply line VSL is the independent signal line, so that the voltage of the voltage supply line VSL needs to be controlled separately.

When the voltage supply line VSL extends in the vertical direction (column direction) so as to be parallel to the source line SL and can be individually driven by the column in the sixth type, the first switch circuit 22 and the second switch circuit 23 could be both put into the connected state in the selected row at the same time similar to the fifth type, so that there is a drive method to set the voltage of the voltage supply line VSL connected to one end of the second switch circuit 23 to the same as that of the source line SL connected to the one end of the first switch circuit 22 paired with the second switch circuit 23. When there is a difference between the source line SL and the voltage supply line VSL connected to the first switch circuit 22 and the second switch circuit 23 which have been put into the connected state at the same time, respectively, during the programming action, there is a possibility that a current path is generated between the source line SL and the voltage supply line VSL, and a voltage of the node positioned between them fluctuates, so that the pixel voltage V20 could not be correctly programmed in the internal node N1. Thus, the possibility can be excluded by the above drive method. In addition, since 8 V is applied to the reference line REF, and the transistor T2 is in on state, the voltage of the control terminal of the transistor T1 is the same as that of the internal node N1, so that the diode-connected transistor T1 becomes the reversely-biased state (off state) and the first switch circuit 22 in the selected row can be put into the unconnected state by applying a voltage more than an upper limit value of the voltage applied to the source line SL in the programming action. Therefore, the problem (the above possibility) caused when the first switch circuit 22 and the second switch circuit 23 are put into the connected state at the same time in the selected row can be solved without using the above drive method. This means that the sixth type circuit may be constituted such that the voltage supply line VSL extends in the lateral direction (row direction) so as to be parallel to the gate line GL.

In addition, in the programming action in the normal display mode, as a method to invert the polarity of the display line every one horizontal period, other than the above-described “opposite AC driving”, there is a method in which a predetermined fixed voltage is applied to the opposite electrode 80 as the opposite voltage Vcom. In this case, the voltage applied to the pixel electrode 20 alternately becomes a positive voltage and a negative voltage, based on the opposite voltage Vcom every one horizontal period. In this case, there is a method in which the pixel voltage is directly programmed through the source line SL, and a method in which the voltage is adjusted to become the positive voltage or the negative voltage, based on the opposite voltage Vcom by capacitance coupling using the auxiliary capacitance element C2 after the voltage having a voltage range around the opposite voltage Vcom has been programmed. In this case, the auxiliary capacitance line CSL is not driven at the same voltage as the opposite voltage Vcom, but individually driven with pulses by the row. As for the programming action in the normal display mode, by controlling the selection line SEL, the reference line REF, the voltage supply line VSL as described above, the pixel circuits 2A to 2F having the first to sixth type circuit configurations can be applied to various kinds of programming methods.

In addition, this embodiment employs the method for inverting the polarity of the display line every one horizontal period in the programming action in the normal display mode, to solve the following problem generated when the polarity is inverted by the frame. In addition, the method for solving the problem includes a method in which the polarity is inverted by the one column or a method in which the polarity is inverted by the pixel in the row and column directions at the same time.

It is assumed that the liquid crystal voltage Vlc having the positive polarity is applied to all of the pixels in a certain frame F1, and the liquid crystal voltage Vlc having the negative polarity is applied to all of the pixels in the next frame F2. Even when the voltages having the same absolute value are applied to the liquid crystal layer, a fine difference could be generated in light transmissibility depending on the positive polarity or the negative polarity. When a high-quality still picture is displayed, the fine difference could generate a fine change in a display form between the frame F1 and the frame F2. In addition, when a moving picture is displayed, a fine change could be generated in a display form in a display region where the same contents should be displayed among the frames. When the high-quality still picture or moving picture is displayed, such fine change may be visually recognized.

Thus, in the normal display mode, since such high-quality still picture or moving picture is displayed, the above fine change could be visually recognized. In order to avoid this phenomenon, the polarity is inverted every one display line in the same frame in this embodiment. Thus, since the liquid crystal voltage Vlc different in polarity is alternately applied to the display lines in the same frame, the display image data is prevented from being affected by the polarity of the liquid crystal voltage Vlc.

### Other Embodiments

Hereinafter, other embodiments will be described.

<1> In the programming action in the normal display mode and constant display mode, a low level voltage may be applied to the reference line REF to turn off the transistor T2. In this case, the internal node N1 and the output node N2 are electrically isolated from each other, so that a potential of the pixel electrode 20 is not affected by the voltage of the output node N2 before the programming action. Thus, the voltage of the pixel electrode 20 correctly reflects the voltage applied to the source line SL, and the image data can be displayed without error.

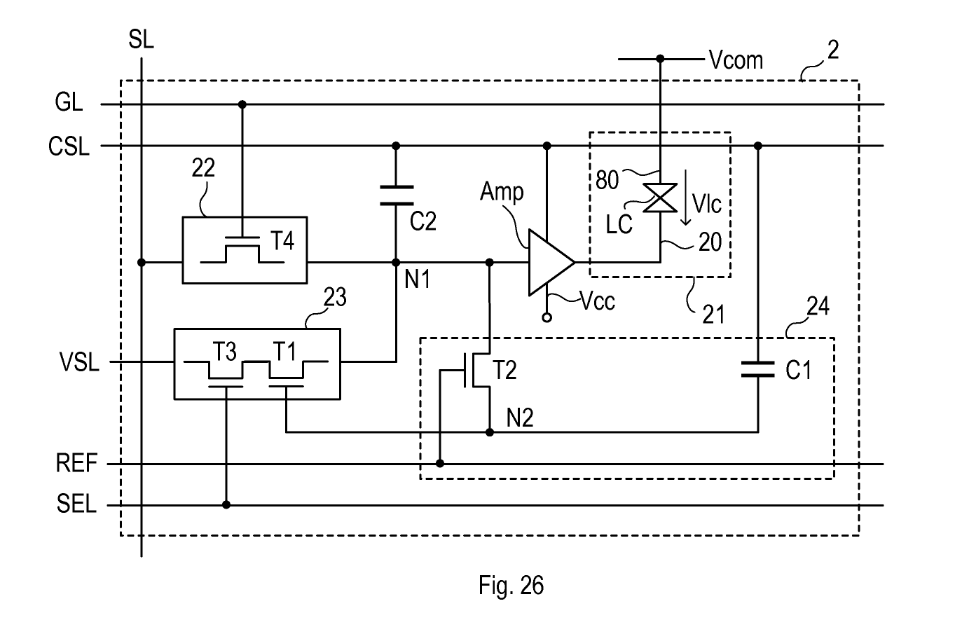

However, when total parasitic capacitance of the internal node N1 is considerably higher than total parasitic capacitance of the output node N2, the voltage of the internal node N1 is hardly affected by the voltage of the output node N2 at the time of the programming action, so that the above problem may not be considered.

<2> The description has been made of the case where the self polarity inverting action is executed for all of the pixel circuits by the frame in the above embodiment, but one frame may be divided into a plurality of row groups having a predetermined number of rows, and the self polarity inverting action may be executed by the row group. For example, the self polarity inverting action is executed in the pixel circuit belonging to the even number row, and the next self polarity inverting action is executed in the pixel circuit belonging to the odd number row, and they may be repeated. Thus, by separately executing the self polarity inverting action in the even number row and the odd number row, even when a fine display error is generated due to the self polarity inverting action, the fine error can be dispersed to even number rows or odd number rows, so that an effect on the display image can be further reduced. Similarly, one frame may be divided into a plurality of column groups each having a predetermined number of columns, and the self polarity inverting action may be executed by the column group.
<3> According to the above embodiment, each of the pixel circuit 2 arranged on the active matrix substrate 10 includes the second switch circuit 23 and the control circuit 24. Meanwhile, in a case where two kinds of pixel parts such as a transmissive pixel part to perform a transmissive liquid crystal display and a reflective pixel part to perform a reflective liquid crystal display are formed on the active matrix substrate 10, only a pixel circuit of the reflective pixel part has the second switch circuit 23 and the control circuit 24, and a pixel circuit of the transmissive display part may not have the second switch circuit 23 and the control circuit 24. In this case, the image is displayed by the transmissive pixel part in the normal display mode, and the image is displayed by the reflective pixel part in the constant display mode. In this configuration, the number of the elements formed on the whole active matrix substrate 10 can be reduced.
<4> While each of the pixel circuit 2 includes the auxiliary capacitance element C2 in the above embodiment, the auxiliary capacitance element C2 may not be provided. In addition, the auxiliary capacitance line CSL connected to the auxiliary capacitance element C2, and the auxiliary capacitance line CSL connected to the first capacitance element C1 may be composed of different signal lines, and in this case, the different fixed voltages may be applied thereto.
<5> The description has been made of the case where the display element part 21 of the pixel circuit 2 is only composed of the unit liquid crystal display element LC in the above embodiment, but as shown in FIG. 26, an analog amplifier Amp (voltage amplifier) may be provided between the internal node N1 and the pixel electrode 20. In FIG. 26, as a power line of the analog amplifier Amp, the auxiliary capacitance line CSL and a power line Vcc are inputted, as one example.

In this case, the voltage applied to the internal node N1 is amplified by an amplification factor η set by the analog amplifier Amp, and the amplified voltage is supplied to the pixel electrode 20. Therefore, a fine voltage change of the internal node N1 can be reflected in the display image.

In addition, in the case shown in FIG. 26, in the self polarity inverting action in the constant display mode, the voltage of the internal node N1 is amplified by the amplification factor η and supplied to the pixel electrode 20, so that by adjusting a voltage difference between the first and second voltage states applied to the source line SL and the voltage supply line VSL (including the case where the source line SL, reference line REF, or the auxiliary capacitance line CSL also serves as the voltage supply line VSL), the voltages in the first voltage states and second voltage states supplied to the pixel electrode 20 can conform to the opposite voltages Vcom at high level and low level.

<6> The above embodiment assumes that the transistors T1 to T4 in the pixel circuit 2 are the N-channel type polycrystalline silicon TFTs, but they may be P-channel type TFTs or amorphous silicon TFTs. In the display device using the P-channel type TFT also, the pixel circuit 2 can be operated similarly to the above embodiments and the same effect can be obtained by inverting plus and minus of the power supply voltage and the voltage values shown as the above action condition, by reversing the applied voltage between the case A and the case B, or by replacing the first voltage state (5 V) and the second voltage state (0V) with the first voltage state (0 V) and the second voltage state (5 V) in the programming action in the constant display mode. <7> The above embodiment assumes that 0 V and 5 V are set as the voltage values of the pixel voltage V20 and the opposite voltage Vcom in the first and second voltage states in the constant display mode, and based on that, −5 V, 0 V, 5 V, and 8 V are set as the voltage values applied to the signal line, but these voltage values can be appropriately changed according to the characteristics (such as the threshold voltage) of the liquid crystal element and the transistor to be used.

### EXPLANATION OF REFERENCES

1: DISPLAY DEVICE
2, 2A to 2F: PIXEL CIRCUIT
10: ACTIVE MATRIX SUBSTRATE
11: DISPLAY CONTROL CIRCUIT
12: OPPOSITE ELECTRODE DRIVE CIRCUIT
13: SOURCE DRIVER
14: GATE DRIVER
20: PIXEL ELECTRODE
21: DISPLAY ELEMENT PART
22: FIRST SWITCH CIRCUIT
23: SECOND SWITCH CIRCUIT
24: CONTROL CIRCUIT
74: SEAL MATERIAL
75: LIQUID CRYSTAL LAYER
80: OPPOSITE ELECTRODE
81: OPPOSITE SUBSTRATE
C1: FIRST CAPACITANCE ELEMENT
C2: AUXILIARY CAPACITANCE ELEMENT
CML: OPPOSITE ELECTRODE WIRING
CSL: AUXILIARY CAPACITANCE LINE
Ct: TIMING SIGNAL
DA: DIGITAL IMAGE SIGNAL
Dv: DATA SIGNAL
GL (GL1, GL2, . . . , GLn): GATE LINE
Gtc: SCAN SIDE TIMING CONTROL SIGNAL
LC: UNIT LIQUID CRYSTAL DISPLAY ELEMENT
N1: INTERNAL NODE
N2: OUTPUT NODE
REF: REFERENCE LINE
SEL: SELECTION LINE
Sec: OPPOSITE VOLTAGE CONTROL SIGNAL
SL (SL1, SL2, . . . , SLm): SOURCE LINE
Stc: DATA SIDE TIMING CONTROL SIGNAL
T1, T2, T3, T4: TRANSISTOR
V20: PIXEL VOLTAGE
Vcom: OPPOSITE VOLTAGE
Vlc: LIQUID CRYSTAL VOLTAGE

1. A pixel circuit comprising:
a display element part including a unit liquid crystal display element;
an internal node serving as a part of the display element part, adapted to hold a voltage of pixel data applied to the display element part;
a first switch circuit adapted to transfer the voltage of the pixel data supplied from a data signal line to the internal node through at least a predetermined switch element;
a second switch circuit adapted to transfer a voltage supplied to a predetermined voltage supply line to the internal node without going through the switch element; and
a control circuit adapted to hold a predetermined voltage depending on the voltage of the pixel data held in the internal node, at one end of a first capacitance element, and control connection/disconnection of the second switch circuit, wherein
the second switch circuit and the control circuit comprise first to third transistor elements each having a first terminal, a second terminal, and a control terminal to control connection between the first and second terminals, and the first capacitance element,
the second switch circuit comprises a series circuit of the first transistor element and the third transistor element,
the control circuit comprises a series circuit of the second transistor element and the first capacitance element,
one end of the first switch circuit is connected to the data signal line,
one end of the second switch circuit is connected to the voltage supply line,
each of other ends of the first and second switch circuits, and the first terminal of the second transistor element are connected to the internal node,
the control terminal of the first transistor element, the second terminal of the second transistor element, and the one end of the first capacitance element are mutually connected,
the control terminal of the second transistor element is connected to a first control line,
the control terminal of the third transistor element is connected to a second control line, and
the other end of the first capacitance element is connected to a predetermined fixed voltage line.

2. The pixel circuit according to claim 1, comprising:
a second capacitance element having one end connected to the internal node, and the other end connected to the fixed voltage line, wherein
the fixed voltage line functions as a third control line to control the voltage of the internal node by capacitance coupling through the second capacitance element.

3. The pixel circuit according to claim 1, wherein
the switch element comprises a fourth transistor element having a first terminal, a second terminal, and a control terminal adapted to control connection between the first and second terminals, and
the control terminal of the fourth transistor element is connected to a scanning signal line.

4. The pixel circuit according to claim 1, wherein
the first switch circuit consists of the switch element.

5. The pixel circuit according to claim 1, wherein
the first switch circuit comprises a series circuit of the switch element and the third transistor element, or a series circuit of the switch element and a fifth transistor element having a control terminal connected to the control terminal of the third transistor element.

6. The pixel circuit according to claim 4, wherein
the first control line also serves as the voltage supply line.

7. The pixel circuit according to claim 4, wherein
the fixed voltage line also serves as the voltage supply line.

8. The pixel circuit according to claim 4, wherein
the data signal line also serves as the voltage supply line.

9. The pixel circuit according to claim 5, wherein
the data signal line also serves as the voltage supply line.

10. A display device comprising a pixel circuit array provided by arranging a plurality of pixel circuits each according to claim 1 in a row direction and a column direction, wherein
the data signal line is provided every one column,
the one end of the first switch circuit in each of the pixel circuits arranged in the same column is connected to a common data signal line,
the control terminal of the second transistor element in each of the pixel circuits arranged in the same row or the same column is connected to a common first control line,
the control terminal of the third transistor element in each of the pixel circuits arranged in the same row or the same column is connected to a common second control line,
the other end of the first capacitance element in each of the pixel circuits arranged in the same row or the same column is connected to a common fixed voltage line,
a data signal line drive circuit adapted to drive the data signal lines separately is provided,
a control line drive circuit adapted to drive the first control line, the second control line, and the fixed voltage line separately is provided,
the data signal line drive circuit drives the voltage supply line in a case where the data signal line also serves as the voltage supply line, and
the control line drive circuit drives the voltage supply line in a case where the first control line or the fixed voltage line also serves as the voltage supply line, or the voltage supply line is an independent wire.

11. The display device according to claim 10, wherein
in a case where none of the first control line, the fixed voltage line, or the data signal line also serves as the voltage supply line, and the voltage supply line is the independent wire,
the one end of the second switch circuit in each of the pixel circuits arranged in the same row or the same column is connected to a common voltage supply line.

12. The display device according to claim 10, wherein
the first switch circuit consists of the switch element including a fourth transistor element having a first terminal, a second terminal, and a control terminal adapted to control connection between the first and second terminals,
the first terminal is connected to the internal node, the second terminal is connected to the data signal line, and the control terminal is connected to a scanning signal line in the fourth transistor element,
the scanning signal line is provided every one row,
the pixel circuits arranged in the same row are connected to a common scanning signal line, and
a scanning signal line drive circuit to drive the scanning signal lines separately is provided.

13. The display device according to claim 10, wherein
the first switch circuit comprises a series circuit of the switch element including a fourth transistor element having a first terminal, a second terminal and a control terminal adapted to control connection between the first and second terminals, and the third transistor element, or a series circuit of the switch element and a fifth transistor element having a control terminal connected to the control terminal of the third transistor element,
the control terminal of the fourth transistor element is connected to a scanning signal line,
the scanning signal line and the second control line are each provided every one row,
the pixel circuits arranged in the same row are connected to each of a common scanning signal line and the common second control line,
a scanning signal line drive circuit adapted to drive the scanning signal lines separately is provided, and
the voltage supply line also serves as the data signal line or is the independent wire.

14. The display device according to claim 12, wherein
at the time of a programming action to separately program the pixel data in the pixel circuits arranged in one selected row,
the scanning signal line drive circuit applies a predetermined selected row voltage to the scanning signal line in the selected row to turn on the fourth transistor element arranged in the selected row, and applies a predetermined unselected row voltage to the scanning signal line in a row other than the selected row to turn off the fourth transistor element arranged in the row other than the selected row, and
the data signal line drive circuit separately applies a data voltage corresponding to the pixel data to be programmed in the pixel circuit in each column in the selected row, to each of the data signal lines.

15. The display device according to claim 14, wherein
at the time of the programming action,
the control line drive circuit applies a predetermined voltage to turn off the third transistor element, to the second control line.

16. The display device according to claim 14, wherein
in a case where the data signal line does not serve as the voltage supply line at the time of the programming action,
the control line drive circuit applies a predetermined voltage to the first control line to turn on the second transistor element regardless of a voltage state of the internal node, and applies a predetermined voltage to the voltage supply line to turn off the first transistor element, and puts the second switch circuit into an unconnected state.

17. The display device according to claim 13, wherein
at the time of a programming action to separately program the pixel data in the pixel circuits arranged in one selected row,
the scanning signal line drive circuit applies a predetermined selected row voltage to the scanning signal line in the selected row to turn on the fourth transistor element arranged in the selected row, and applies a predetermined unselected row voltage to the scanning signal line in a row other than the selected row to turn off the fourth transistor element arranged in the row other than the selected row,
the control line drive circuit applies a predetermined selecting voltage to the second control line in the selected row to turn on the third transistor element, and applies a predetermined non-selecting voltage to the second control line in the row other than the selected row to turn off the third transistor element, and
the data signal line drive circuit separately applies a data voltage corresponding to the pixel data to be programmed in the pixel circuit in each column in the selected row, to each of the data signal lines.

18. The display device according to claim 13, wherein
in a case where the voltage supply line is the independent wire at the time of a programming action to separately program the pixel data in the pixel circuits arranged in one selected row,
the scanning signal line drive circuit applies a predetermined selected row voltage to the scanning signal line in the selected row to turn on the fourth transistor element arranged in the selected row, and applies a predetermined unselected row voltage to the scanning signal line in a row other than the selected row to turn off the fourth transistor element arranged in the row other than the selected row,
the control line drive circuit applies a predetermined selecting voltage to the second control line in the selected row to turn on the third transistor element, applies a predetermined voltage to the first control line to turn on the second transistor element regardless of a voltage state of the internal node, applies a predetermined voltage to the voltage supply line to turn off the first transistor element, and puts the second switch circuit into an unconnected state, and
the data signal line drive circuit separately applies a data voltage corresponding to the pixel data to be programmed in the pixel circuit in each column in the selected row, to each of the data signal lines.

19. The display device according to claim 14, wherein
at the time of the programming action,
the control line drive circuit applies a predetermined voltage to turn on the second transistor element, to the first control line.

20. The display device according to claim 14, wherein
at the time of the programming action,
the control line drive circuit applies a predetermined voltage to turn off the second transistor element, to the first control line.

21. The display device according to claim 14, wherein
after the programming action,
the scanning signal line drive circuit applies a predetermined voltage to the scanning signal line connected to all of the pixel circuits in the pixel circuit array to turn off the fourth transistor element,
the control line drive circuit
applies a predetermined voltage to the second control line to turn off the third transistor element, or in a case where the data signal line does not serve as the voltage supply line, applies a predetermined voltage to the voltage supply line to turn off the first transistor element, and puts the second switch circuit into the unconnected state, and
applies a predetermined voltage to the first control line so that a difference is generated in voltage value induced at one end of the first capacitance element through the second transistor element, depending on whether a voltage state of binary pixel data held in the internal node is a first voltage state or a second voltage state, and in a case where a voltage of the first or second terminal of the first transistor element is in the second voltage state, the first transistor element is turned on when the internal node is in the first voltage state, and the first transistor element is turned off when the internal node is in the second voltage state, due to the difference in voltage value at the one end of the first capacitance element.

22. The display device according to claim 12, wherein
the unit liquid crystal display element comprises a pixel electrode, an opposite electrode, and a liquid crystal layer sandwiched between the pixel electrode and the opposite electrode,
the internal node is connected to the pixel electrode directly or through a voltage amplifier in the display element part,
an opposite electrode voltage supply circuit adapted to supply a voltage to the opposite electrode is provided,
in a self polarity inverting action to activate the first switch circuits, the second switch circuits, and the control circuits to invert polarities of voltages applied between the pixel electrodes and the opposite electrodes in the plurality of pixel circuits at the same time,
as an initial state setting action before the self polarity inverting action,
the scanning signal line drive circuit applies a predetermined voltage to the scanning signal lines connected to all of the pixel circuits in the pixel circuit array to turn off the fourth transistor element,
the control line drive circuit applies a predetermined voltage to the first control line so that a difference is generated in voltage value induced at one end of the first capacitance element through the second transistor element, depending on whether a voltage state of binary pixel data held in the internal node is a first voltage state or a second voltage state, and in a case where a voltage of the first or second terminal of the first transistor element is in the second voltage state, the first transistor element is turned on when the internal node is in the first voltage state, and the first transistor element is turned off when the internal node is in the second voltage state, due to the difference in voltage value at the one end of the first capacitance element, and applies a predetermined fixed voltage to the fixed voltage line,
the control line drive circuit applies a predetermined voltage to the second control line to turn off the third transistor element, or in a case where the data signal line does not serve as the voltage supply line, applies a predetermined voltage to the voltage supply line to turn off the first transistor element, and puts the second switch circuit into the unconnected state,
after the initial state setting action,
the control line drive circuit applies a predetermined voltage to the first control line to turn off the second transistor element regardless of whether the internal node is in the first voltage state or the second voltage state,
scanning signal line drive circuit applies a voltage pulse having a predetermined voltage amplitude to all of the scanning signal lines connected to the plurality of pixel circuits serving as a target of the self polarity inverting action, turns on the fourth transistor element temporarily, and turns off the fourth transistor element,
the opposite electrode voltage supply circuit changes a voltage applied to the opposite electrode between two voltage states after the second transistor element has been turned off, before the scanning signal line drive circuit completes the application of the voltage pulse,
the control line drive circuit applies a predetermined voltage to the second control line to turn on the third transistor element during at least a predetermined period after the scanning signal line drive circuit has completed the application of the voltage pulse,
the data signal line drive circuit applies a voltage in the first voltage state to all of the data signal lines connected to the pixel circuits serving as the target of the self polarity inverting action at least while the scanning signal line drive circuit applies the voltage pulse, and
the data signal line drive circuit or the control line drive circuit applies a voltage in the second voltage state to all of the voltage supply lines connected to the pixel circuits serving as the target of the self polarity inverting action during at least one part of a period just before the control line drive circuit completes the application of the predetermined voltage to turn on the third transistor element to the second control line.

23. The display device according to claim 22, wherein
in a case where the first control line also serves as the voltage supply line,
after the initial state setting action, the control line drive circuit applies the voltage in the second voltage state to the first control line as the predetermined voltage to turn off the second transistor element regardless of the voltage state of the internal node.

24. The display device according to claim 22, wherein
in a case where the fixed voltage line also serves as the voltage supply line,
the control line drive circuit applies the voltage in the second voltage state as the predetermined fixed voltage in the initial state setting action.

25. The display device according to claim 22, wherein
a second capacitance element having one end connected to the internal node and the other end connected to a fixed voltage line is provided, and
in a case where the fixed voltage line functions as a third control line to control a voltage of the internal node by capacitance coupling through the second capacitance element,
after the scanning signal line drive circuit has completed the application of the voltage pulse, a voltage fluctuation of the internal node generated after the application of the voltage pulse is compensated by adjusting a voltage of the fixed voltage line.

26. The display device according to claim 13, wherein
the unit liquid crystal display element comprises a pixel electrode, an opposite electrode, and a liquid crystal layer sandwiched between the pixel electrode and the opposite electrode,
the internal node is connected to the pixel electrode directly or through a voltage amplifier in the display element part,
an opposite electrode voltage supply circuit adapted to supply a voltage to the opposite electrode is provided,
in a self polarity inverting action to activate the first switch circuits, the second switch circuits, and the control circuits to invert polarities of voltages applied between the pixel electrodes and the opposite electrodes in the plurality of pixel circuits at the same time,
as an initial state setting action before the self polarity inverting action,
the scanning signal line drive circuit applies a predetermined voltage to the scanning signal line connected to all of the pixel circuits in the pixel circuit array and turns off the fourth transistor element,
the control line drive circuit applies a predetermined voltage to the first control line so that a difference is generated in voltage value induced at one end of the first capacitance element through the second transistor element, depending on whether a voltage state of binary pixel data held in the internal node is a first voltage state or a second voltage state, and in a case where a voltage of the first or second terminal of the first transistor element is in the second voltage state, the first transistor element is turned on when the internal node is in the first voltage state, and the first transistor element is turned off when the internal node is in the second voltage state, due to the difference in voltage value at the one end of the capacitance element, and applies a predetermined fixed voltage to the fixed voltage line,
the control line drive circuit applies a predetermined voltage to the second control line to turn off the third transistor element, or in a case where the voltage supply line is the independent wire, applies a predetermined voltage to the voltage supply line to turn off the first transistor element, and puts the second switch circuit into the unconnected state,
after the initial state setting action,
the control line drive circuit applies a predetermined voltage to the first control line to turn off the second transistor element regardless of whether the internal node is in the first voltage state or the second voltage state,
scanning signal line drive circuit applies a voltage pulse having a predetermined voltage amplitude to all of the scanning signal lines connected to the plurality of pixel circuits serving as a target of the self polarity inverting action, turns on the fourth transistor element temporarily, and turns off the fourth transistor element,
the opposite electrode voltage supply circuit changes a voltage applied to the opposite electrode between two voltage states after the second transistor element has been turned off, before the scanning signal line drive circuit completes the application of the voltage pulse,
the control line drive circuit applies a predetermined voltage to the second control line to turn on the third transistor element at least during a period when the scanning signal line drive circuit applies the voltage pulse and a predetermined period after the application has been completed,
the data signal line drive circuit applies a voltage in the first voltage state to all of the data signal lines connected to the pixel circuits serving as the target of the self polarity inverting action at least while the scanning signal line drive circuit applies the voltage pulse, and
the data signal line drive circuit or the control line drive circuit applies the voltage in the first voltage state at least while the scanning signal line drive circuit applies the voltage pulse, and applies a voltage in the second voltage state after the scanning signal line drive circuit has completed the application of the voltage pulse and during at least one part of a period just before the control line drive circuit completes the application of a predetermined voltage to turn on the third transistor element to the second control line, to all of the voltage supply lines connected to the pixel circuits serving as the target of the self polarity inverting action.

27. The display device according to claim 26, wherein
a second capacitance element having one end connected to the internal node and the other end connected to a fixed voltage line is provided, and
in a case where the fixed voltage line functions as a third control line to control a voltage of the internal node by capacitance coupling through the second capacitance element,
after the scanning signal line drive circuit has completed the application of the voltage pulse, a voltage fluctuation of the internal node generated at the completion of the application of the voltage pulse is compensated by adjusting a voltage of the fixed voltage line.

28. The display device according to claim 22, wherein
after a series of actions following the initial state setting action has been completed,
the control line drive circuit
applies a predetermined voltage to the second control line to turn off the third transistor element, or in a case where the data signal line does not serve as the voltage supply line, applies a predetermined voltage to the voltage supply line to turn off the first transistor element, and puts the second switch circuit into the unconnected state, and
applies a predetermined voltage to the first control line so that a difference is generated in voltage value induced at one end of the first capacitance element through the second transistor element depending on whether the voltage state of the binary pixel data held in the internal node is in a first voltage state or a second voltage state, and in a case where a voltage of the first or second terminal of the first transistor element is in the second voltage state, the first transistor element is turned on when the internal node is in the first voltage state, and the first transistor element is turned off when the internal node is in the second state, due to the difference in voltage value at the one end of the first capacitance element.

29. The display device according to claim 26, wherein
after a series of actions following the initial state setting action has been completed,
the control line drive circuit
applies a predetermined voltage to the second control line to turn off the third transistor element, or in a case where the data signal line does not serve as the voltage supply line, applies a predetermined voltage to the voltage supply line to turn off the first transistor element, and puts the second switch circuit into the unconnected state, and
applies a predetermined voltage to the first control line so that a difference is generated in voltage value induced at one end of the first capacitance element through the second transistor element depending on whether the voltage state of the binary pixel data held in the internal node is in a first voltage state or a second voltage state, and in a case where a voltage of the first or second terminal of the first transistor element is in the second voltage state, the first transistor element is turned on when the internal node is in the first voltage state, and the first transistor element is turned off when the internal node is in the second state, due to the difference in voltage value at the one end of the first capacitance element.
